(19) United States
(12) Patent Application Publication
(10) Pub. No.: US 2011/0197363 A1
(43) Pub. Date: Aug. 18, 2011

(54) COMPOSITE CUSHIONING STRUCTURE(S) WITH SPATIALLY VARIABLE CUSHIONING PROPERTIES AND RELATED MATERIALS, CUSHIONING ASSEMBLIES, AND METHODS FOR PRODUCING SAME

(75) Inventors: Stephen C. Kokenes, Raleigh, NC (US); Edouard Lauer, Zebulon, NC (US)

(73) Assignee: NOEL GROUP LLC, Zebulon, NC (US)

(21) Appl. No.: 13/026,979

(22) Filed: Feb. 14, 2011

Related U.S. Application Data
(60) Provisional application No. 61/303,953, filed on Feb. 12, 2010.

(51) Int. Cl. B68G 5/02; A47C 20/00; B32B 3/26; B32B 37/12; B32B 7/12; B29C 45/14; B29C 39/10; B29C 49/00

(52) U.S. Cl. 5/652; 428/304.4; 428/316.6; 428/314.4; 428/317.1; 264/267; 156/242

(57) ABSTRACT

Composite cushioning structures with spatially variable cushioning properties and related materials and methods for producing same are disclosed. In one embodiment, gradient property foam (GPF) is provided and comprised of a two or more phase composite cushioning structure comprised of a spatially variable disposition of one or more second non-solid phase cushioning component into a first solid phase cellular cushioning component to control the local cushioning properties of the final composite cushioning structure. The second cushioning component(s) can be selected to exhibit other cushioning properties when in solid form from the cushioning properties of the first cellular cushioning component in this embodiment. In one embodiment, the second cushioning component(s) can undergo a transition from the non-solid phase into a solid phase within the first cellular cushioning component to form a bond with the first cellular cushioning component to form the composite cushioning structure.

### RELATED APPLICATIONS

The present application claims priority to U.S. Provisional Patent Application Ser. No. 61/303,953 filed on Feb. 12, 2010 and entitled “CUSHIONING STRUCTURE(S) WITH SPATIALLY VARIABLE CUSHIONING PROPERTIES AND RELATED MATERIALS AND METHODS FOR PRODUCING SAME,” which is incorporated herein by reference in its entirety.

### BACKGROUND

1. Field of the Disclosure

The technology of the disclosure relates to cushioning structures.

2. Technical Background

Cushioning structures are employed in support applications. Cushioning structures can be employed in bedding and seating applications, as examples, to provide cushioning and support. Cushioning structures may also be employed in devices for safety applications, such as helmets and automobiles for example.

The design of a cushioning structure may be required to have both high and low stiffness. For example, it may be desirable to provide a cushioning material or device in which a body or object will easily sink into the cushion a given distance before the applied weight is supported. As another example, it may be desired to provide surfaces having low stiffness initially during application of weight, while the underlying structure needs to have high stiffness for support and be crushable. These surfaces may be provided in safety applications, such as helmets and automobile dashboards as examples. In this regard, a cushioning structure may be designed that provides an initial large deflection at a low applied force with nonlinearly increasing stiffness at increasing deflection.

To provide a cushioning structure with high and low stiffness features, cushioning structures can be composed of layers of varying thicknesses and properties. Each of these components has different physical properties, and as a result of these properties and variations in thicknesses and location of the components, the cushioning structure has a certain complex response to applied pressure. For example, cushioning structures generally include components made from various types of foam, cloth, fibers and/or steel to provide a general response to pressure that is perceived as comfortable to the individual seeking a place to lie, sit, or rest either the body as a whole or portions thereof. General foam plastic materials can also be used as materials of choice for cushion applications. Foam plastic materials provide a level of cushionability in and of themselves, unlike a steel spring or similar structure. Generally accepted foams fall within two categories: thermosets and thermoplastics.

Thermoset materials exhibit the ability to recover after repeated deformations and provide a generally accepted sleep surface. Thermoplastic foams and specifically closed cell thermoplastic foams, on the other hand, while not having the long time frame repeatable deformation capabilities of the thermoset foams, are suitable to lower density, less weight, and therefore less costly production while maintaining a more structurally stable aspect to their construction.

One example of a cushioning structure employing layers of varying thicknesses and properties for discussion purposes is provided in a mattress 10 of FIG. 1. As illustrated therein, a mattress innerspring 12 (also called “innerspring 12”) is provided. The innerspring 12 is comprised of a plurality of traditional coils 14 arranged in an interconnected matrix to form a flexible core structure and support surfaces of the mattress 10. The coils 14 are also connected to each other through interconnection helical wires 16. Upper and lower border wires 18, 20 are attached to upper and lower end turns of the coils 14 at the perimeter of the array to create a frame for the innerspring 12. The upper and lower border wires 18, 20 also create firmness for edge support on the perimeter of the innerspring 12 where an individual may disproportionally place force on the innerspring 12, such as during mounting onto and dismounting from the mattress 10. The innerspring 12 is disposed on top of a box spring 22 to provide base support.

The coils 14 located proximate to an edge 23 of the innerspring 12 are subjected to concentrated loads as opposed to coils 14 located in an interior 24. To provide further perimeter structure and edge support for the innerspring 12, support members 25 may be disposed around the coils 14 proximate to the edge 23 of the innerspring 12 between the box spring 22 and the upper and lower border wires 18, 20. The support members 25 may be extruded from polymer-foam as an example.

To provide a cushioning structure with high and low stiffness features, various layers of sleeping surface or padding material 26 can be disposed on top of the innerspring 12. The padding material 26 provides a cushioning structure for a load placed on the mattress 10. To provide the cushioning structure with high and low stiffness features, the padding material 26 may consist of multiple layers of materials that may exhibit different physical properties. For example, an uppermost layer 28 may be a soft layer comprised of a thermoset material that allows a load to sink in while exhibiting the ability to recover after repeated deformations. One or more intermediate layers 30 underneath the uppermost layer 28 may be provided to have greater stiffness than the uppermost layer 28 to provide support and pressure spreading that limits the depth to which a load sinks. For example, the intermediate layers 30 may include a thermoset material, such as latex, and/or a thermoplastic material, such as polyethylene foam. A bottom layer 32 may provide a firmer layer than the intermediate layers 30 to provide support. The uppermost layer 28, intermediate layers 30, and bottom layer 32 serve to provide a combination of high and low stiffness characteristics. An upholstery 34 is placed around the entire padding material 26, innerspring 12, and box spring 22 to provide a fully assembled mattress 10.

Because of the various layers provided in the padding material 26, the padding material 26 tends to be tall in height, thus causing the mattress 10 to consume more volume. Increased volume can increase shipping costs. Further, each of the various layers in the padding material 26 must be separately manufactured and stocked for assembly of the mattress 10, adding inventory and storage costs. Further, each of the various layers in the padding material 26 must be disposed in the mattress 10 during assembly, thus adding assembly labor costs to the mattress.

### SUMMARY OF THE DETAILED DESCRIPTION

Embodiments disclosed in the detailed description include composite cushioning structures with spatially variable cushioning properties and related materials and methods for producing same. This is also referred to herein as a gradient property foam (GPF) composite cushioning structure. A GPF composite cushioning structure is a two or more phase composite cushioning structure in which spatially variable distribution of two or more second non-solid phases into a primary solid phase foam controls the local cushioning properties of the final composite cushioning structure. Spatially variable distribution is the distribution of the second cushioning component(s) in a non-uniform manner in at least a portion of the first cushioning component. For example, spatially variable distribution can include spatially varying the density and/or volume of the second cushioning component(s) disposed in at least a portion of the first cushioning component. In this manner, the cushioning characteristics of the first cushioning component can be spatially variably altered by the second cushioning component(s) in the composite cushioning structure to provide the desired cushioning characteristics.

In one embodiment, the composite cushioning structure can be a composite comprised of at least two cushioning components. In one embodiment, a first cushioning component can be a porous substrate comprised of solid polymer material in a primary phase, as an example. In this embodiment, the first cushioning component is selected to provide certain desired cushioning properties when placed under a load. To spatially distribute other desired cushioning properties in the composite cushioning structure that are not provided by the first cushioning component alone, two or more second cushioning components in liquid, gaseous, or plasma form are spatially and variably disposed within the first cushioning component in this embodiment. The second cushioning component(s) is selected to exhibit other cushioning properties when in solid form from the cushioning properties of the first cushioning component in this embodiment.

After initial disposition of the second cushioning component(s) in this embodiment, the second cushioning component(s) may undergo a transition to a solid, thereby forming a cohesive or adhesive union with the first cushioning component to provide a composite cushioning structure with spatially variable properties of both the first cushioning component and second cushioning component(s). In this manner, the second cushioning component(s) in this embodiment can be distributed within the first cushioning component in a variable or non-uniform manner rather than providing the second cushioning component as a separate stratum or layer from the first cushioning component, wherein no portion of the second cushioning component(s) is disposed within the first cushioning component. The variability of distribution or density of the second cushioning component in this embodiment can be controlled to customize the resultant properties of the composite cushioning structure that may not otherwise be possible by providing the second cushioning component as a separate stratum.

In another embodiment, a composite cushioning structure is provided. The composite cushioning structure is comprised of a first cellular cushioning component provided in a solid phase having first cushioning and support characteristics. The composite cushioning structure is also comprised of two or more second cushioning components having second cushioning and support characteristics. The second cushioning component(s) is spatially variably distributed in at least a portion of the first cellular cushioning component to form the composite cushioning structure exhibiting a combination of the first and second cushioning and support characteristics when placed under a load. Further, the second cushioning component(s) can be spatially variably distributed in a non-solid phase in the at least a portion of the first cellular cushioning component such that the second cushioning component(s) may undergo a transition from the non-solid phase into a solid phase within the first cellular cushioning component to form a bond with the first cellular cushioning component to form the composite cushioning structure.

In another embodiment, a method for providing a composite cushioning structure is provided. The method comprises providing a first cellular cushioning component provided in a solid phase having first cushioning and support characteristics. The method also comprises spatially variably distributing two or more second cushioning components having second cushioning and support characteristics in at least a portion of the first cellular cushioning component to form the composite cushioning structure exhibiting a combination of the first and second cushioning and support characteristics when placed under a load.

In another embodiment, a mattress assembly for bedding or seating is provided. The mattress assembly comprises at least one mattress component comprised of a composite cushioning structure formed from a first cellular cushioning component and a second cushioning component. The at least one mattress component comprises a first cellular cushioning component provided in a solid phase having first cushioning and support characteristics. The at least one mattress component also comprises two or more second cushioning components having second cushioning and support characteristics, The second cushioning component(s) may be spatially variably distributed in at least a portion of the first cellular cushioning component to form the composite cushioning structure exhibiting a combination of the first and second cushioning and support characteristics when placed under a load.

As non-limiting examples, the first cellular cushioning component and the second cushioning component could be a thermoplastic or thermoset material. The first cushioning component could be selected from a thermoplastic material to provide a high degree of stiffness to provide structural support for the GPF composite cushioning structure. However, because the thermoplastic material may be prone to compression set over time and does not provide a soft feel to a load, the second cushioning component(s) could be provided as a thermoset precursor, as an example. The thermoset precursor, when in solid form, can provide an offset to compression set to counteract compression set occurring in the thermoplastic material while also exhibiting soft cushioning properties. Thus, the composite cushioning structure in this example can be provided to exhibit both the desired cushioning properties of a thermoplastic material and a thermoset material. Because of the ability to variably control the distribution or density of the second cushioning component(s), the resultant properties of the composite cushioning structure can be provided as desired that may not otherwise be possible by providing the second cushioning component(s) as a separate stratum. Advantages in this example include, but are not limited to, compression recovery, reduced weight, fewer layers of cushioning material, less labor in assembly, smaller form factor of the composite cushioning structure, less inventory, and/or antimicrobial features.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is an exemplary prior art mattress employing an innerspring of wire coils;

FIG. 2 is a chart of exemplary performance curves showing deflection under a given pressure for different types of composite cushioning structures;

FIG. 3 is an exemplary gradient property foam (GPF) composite cushioning structure having spatially variable cushioning properties;

FIGS. 4A-4D are alternative exemplary GPF composite cushioning structures having spatially variable cushioning properties;

FIG. 5 is a chart of exemplary performance curves showing load deflection curves from two regions of a GPF composite cushioning structure having a second cushioning component of latex injected into a first cushioning component of open-cell polyurethane foam;

FIGS. 6A and 6B are exemplary diagrams of an injection machine for injecting a second cushioning component into a first cushioning component;

FIG. 7 is an exemplary diagram of an infusion-blowing process to dispose a second cushioning component into a first cushioning component;

FIGS. 8A and 8B are a table illustrating formulations used in trials of GPF based on various parameters, including equipment, pump speed, needle height, and volume of a latex injected into polyurethane foam;

FIG. 9 is a chart illustrating compressive stress-strain response of three different open-cell polyurethane foams;

FIG. 10 is a chart illustrating compressive stress-strain response of open-cell polyurethane foam before and after being infused with latex by centrifugation to provide GPF;

FIG. 11 is a chart illustrating compressive stress-strain response of open-cell polyurethane foam before and after being infused with latex by injection to provide GPF;

FIG. 12 is a window chart illustrating data from an experiment of pressurized air to distribute latex into polyurethane foam to provide GPF;

FIG. 13 is an indentation deflection mapping chart observed from a GPF composite cushioning structure formed from a diagonal boundary of latex injected into open-cell polyurethane foam;

FIG. 14 is another indentation deflection mapping chart observed from a GPF composite cushioning structure formed from a diagonal boundary of latex injected into open-cell polyurethane foam;

FIG. 15 is an indentation deflection mapping chart observed from a GPF composite cushioning structure formed by injection of latex into open-cell polyurethane foam;

FIG. 16 is an indentation deflection mapping chart observed from a GPF composite cushioning structure formed by injection of latex into approximately half of the volume of the open-cell polyurethane foam;

FIG. 17 is an exemplary diagram of a perspective profile of a GPF composite cushioning structure having spatially variable cushioning properties suitable for a bedding or seating cushioning application;

FIG. 18A is another exemplary diagram of a perspective profile of a GPF composite cushioning structure having spatially variable cushioning properties suitable for a bedding or seating cushioning application;

FIG. 18B is another exemplary diagram of a perspective profile of a GPF composite cushioning structure having spatially variable cushioning properties disposed on a base foam member suitable for a bedding or seating cushioning application;

FIG. 18C is another exemplary diagram of a perspective profile of a GPF composite cushioning structure having spatially variable cushioning properties comprised of a second cushioning component disposed in a non-woven mat and disposed on a base foam member suitable for a bedding or seating cushioning application;

FIG. 19 is an exemplary cross-section profile of a mattress employing a GPF composite cushioning structure having spatially variable cushioning properties suitable for a bedding or seating cushioning application; and

FIG. 20 is an exemplary mattress component employing a GPF composite cushioning structure having spatially variable cushioning properties suitable for a bedding or seating cushioning application.

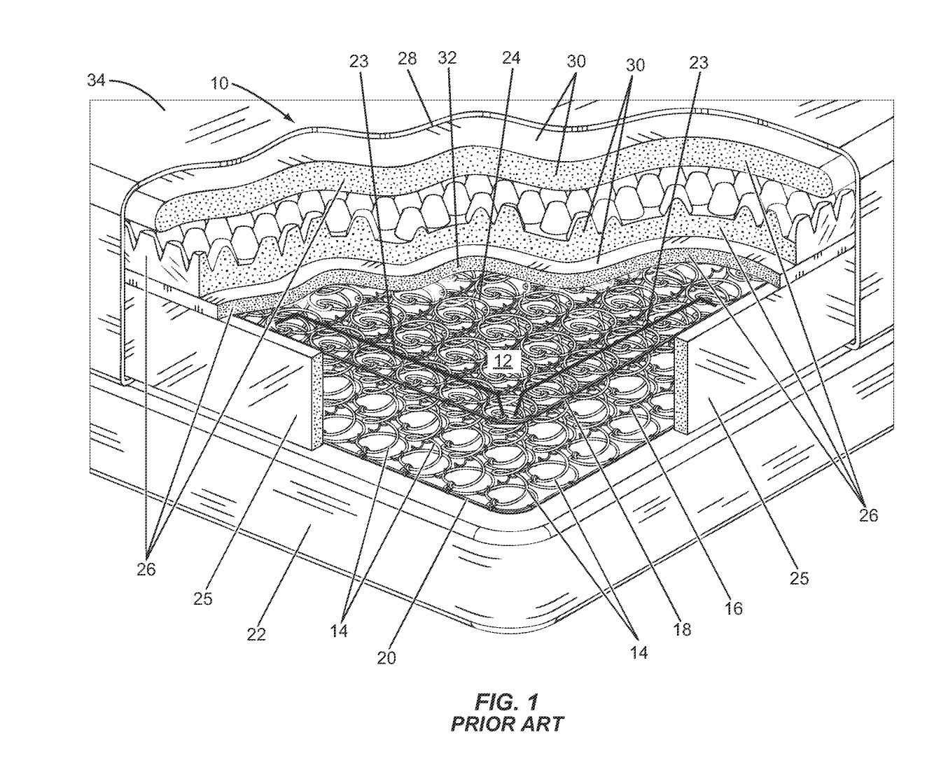

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include composite cushioning structures with spatially variable cushioning properties and related materials and methods for producing same. This is also referred to herein as a gradient property foam (GPF) composite cushioning structure. A GPF composite cushioning structure is a two or more phase composite cushioning structure in which spatially variable distribution of two or more second non-solid phases into a primary solid phase foam controls the local cushioning properties of the final composite cushioning structure. Spatially variable distribution is the distribution of the second cushioning component(s) in a non-uniform manner in at least a portion of the first cushioning component. For example, spatially variable distribution can include spatially varying the density and/or volume of the second cushioning component(s) disposed in at least a portion of the first cushioning component. In this manner, the cushioning characteristics of the first cushioning component can be spatially variably altered by the second cushioning component(s) in the composite cushioning structure to provide the desired cushioning characteristics.

In one embodiment, the composite cushioning structure can be a composite comprised of at least two cushioning components. In one embodiment, a first cushioning component can be a porous substrate comprised of solid polymer material in a primary phase, as an example. The polymer material could be foamed. In this embodiment, the first cushioning component is selected to provide certain desired cushioning properties when placed under a load. To spatially distribute other desired cushioning properties in the cushioning structure that are not provided by the first cushioning component alone, two or more second cushioning components in liquid, gaseous, or plasma form are disposed within the first cushioning component in this embodiment. The second cushioning component(s) is selected to exhibit other cushioning properties when in solid form from the cushioning properties of the first cushioning component in this embodiment.

After initial disposition in this embodiment, the second cushioning component(s) can undergo a transition to a solid, thereby forming a cohesive or adhesive union with the first cushioning component to provide a composite cushioning structure with spatially variable properties of both the first cushioning component and second cushioning component(s). In this manner, the second cushioning component(s) in this embodiment can be distributed within the first cushioning component in a variable or non-uniform manner rather than providing the second cushioning component(s) as a separate stratum from the first cushioning component wherein no portion of the second cushioning component(s) is not disposed into or within the first cushioning component. The variability of distribution or density of the second cushioning component(s) in this embodiment can be controlled to provide GPF to customize the resultant properties of the composite cushioning structure that may not otherwise be possible by providing the second cushioning component(s) as a separate stratum.

As non-limiting examples, the first cushioning component and the second cushioning component could be a thermoplastic or thermoset material. The first cushioning component could be selected from a thermoplastic material to provide a high degree of stiffness to provide structural support for the GPF composite cushioning structure. However, because the thermoplastic material may be prone to compression set over time and does not provide a soft feel to a load, the second cushioning component(s) could be provided as a thermoset precursor, as an example. The thermoset precursor, when in solid form, can provide an offset to compression set to counteract compression set occurring in the thermoplastic material while also exhibiting soft cushioning properties. Thus, the composite cushioning structure in this example can be provided to exhibit both the desired cushioning properties of a thermoplastic material and a thermoset material. Because of the ability to variably control the distribution or density of the second cushioning component(s), the resultant properties of the GPF composite cushioning structure can be provided as desired that may not otherwise be possible by providing the second cushioning component(s) as a separate stratum. Advantages in this example include, but are not limited to, compression recovery, reduced weight, fewer layers of cushioning material, less labor in assembly, smaller form factor of the composite cushioning structure, less inventory, and/or antimicrobial features.

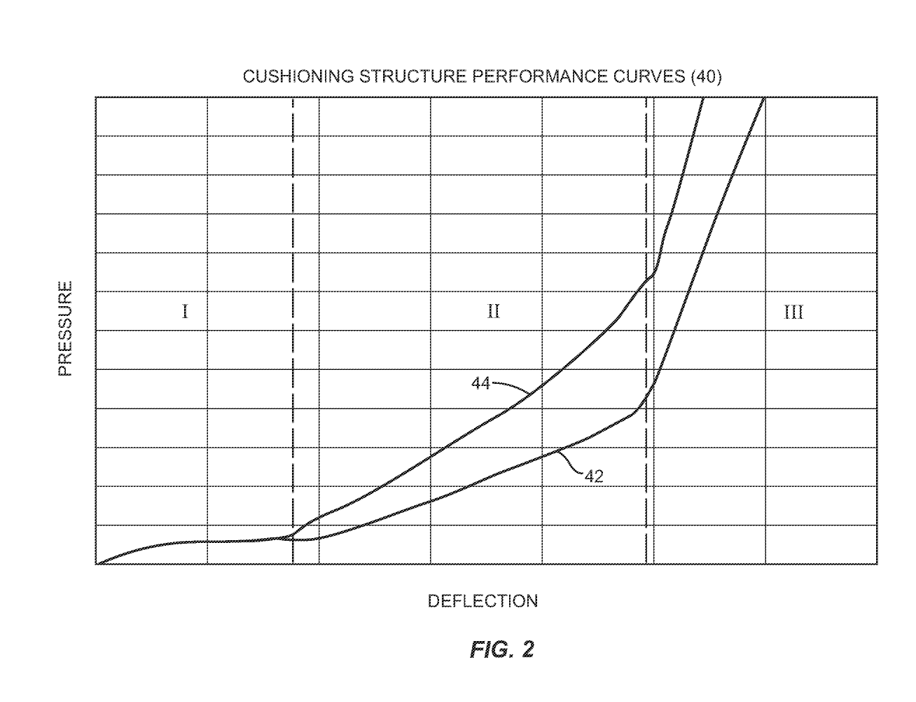

Before discussing the examples of composite cushioning structures having spatially variable properties, a discussion of pressure versus deflection for cushioning structures is first provided. In this regard, FIG. 2 illustrates an exemplary chart 40 of performance curves 42, 44 showing deflection under a given pressure for different types of cushioning structures. The performance curve 42 illustrates deflection of an exemplary cushioning structure that exhibits softness and support properties, but through separate stratum or components wherein no portion of the second cushioning component(s) is disposed within the first cushioning component, rather than providing these properties as spatially variable properties in a cushioning structure. As illustrated in Section I of the chart 40, when a low pressure is placed on the cushioning structure represented by the performance curve 42, the cushioning structure exhibits a large deflection as a percentage of pressure. As pressure increases as provided in Section II of the chart 40, the cushioning structure represented by the performance curve 42 continues to deflect, but the deflection is smaller as a percentage of pressure than the deflection in Section I of the chart 40. This represents the firmer structural properties of the cushioning structure providing a greater role in the cushioning structure response to the increased pressure, thus decreasing the softness feel. As the pressure further increases as shown in Section III of the chart 40, eventually, the cushioning structure represented by the performance curve 42 will exhibit even greater firmness where deflection is very small as a percentage of pressure or non-existent.

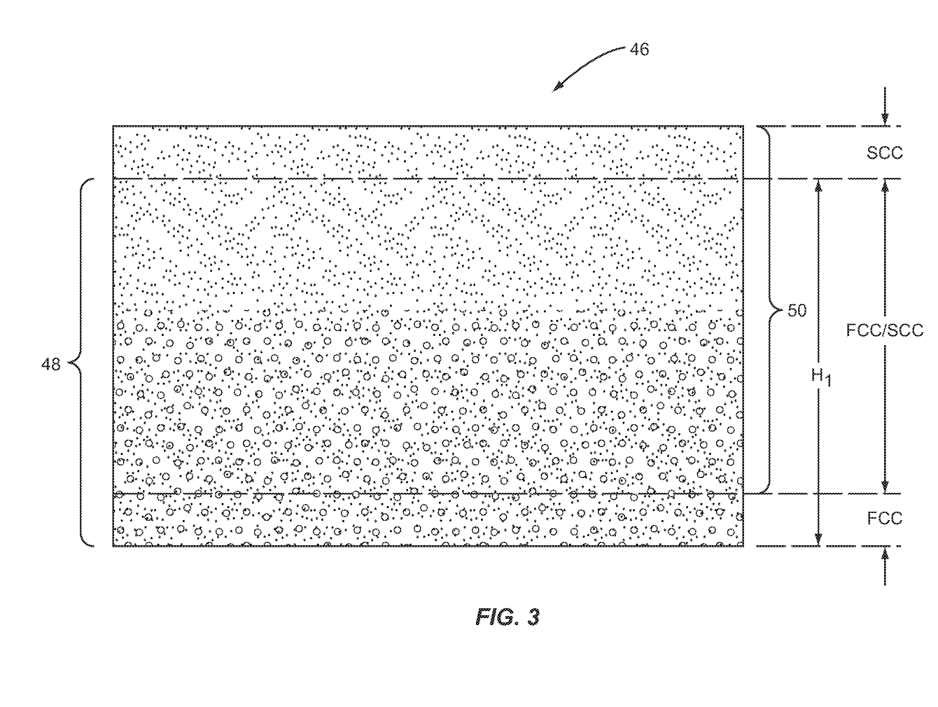

It may be desired to be able to precisely control the deflection versus pressure response of a cushioning structure. For example, it may be desired to provide a cushioning structure that has the deflection versus pressure characteristics of the performance curve 42 in some instances, but, for example, has the deflection versus pressure characteristics of the performance curve 44 in FIG. 2 where a greater deflection occurs than in the performance curve 42 for a given amount of pressure. In other words, it may be desirable to variably control the deflection versus pressure characteristics of a cushioning structure. In this regard, embodiments disclosed herein include cushioning structures with spatially variable cushioning properties. An example of such a cushioning structure is illustrated in FIG. 3, described below.

As illustrated in FIG. 3, a profile of a composite cushioning structure 46 is provided that is comprised of at least two cushioning components, a first cushioning component 48 and a second cushioning component 50. Note however that more than two different cushioning components may be provided. More than one second cushioning component can be provided although one second cushioning component 50 is illustrated in FIG. 3 and provided in this example. In this example, the first cushioning component 48 can be a porous substrate comprised of solid polymer material in a primary phase, as an example. The polymer material could be a foamed material. The second cushioning component 50 could also be a foamed material. The first cushioning component 48 and the second cushioning component 50 are not limited to foamed materials. If either or both the first cushioning component 48 and the second cushioning component 50 are foamed materials, the foam can be open-cell foam, closed-cell foam, or partially open or closed cell foam. For example, if the first cushioning component 48 is open-cell foam, a layer or layers of the second cushioning component 50 in non-solid form can be absorbed, as an example. If the first cushioning component 48 is closed-cell foam, non-solid forms of the second cushioning component 50 can be injected inside the closed gas cells of the closed-cell foam, as an example. The first cushioning component 48 may be formed in any manner desired prior to disposition of the second cushioning component 50, including but not limited to extrusion, molding, casting, and other processes known to those skilled in the art.

The first cushioning component 48 and the second cushioning component 50 may be a thermoplastic or thermoset material, as examples. Examples of thermoset materials include polyurethanes, melamine-formaldehyde, silicone, polyester, and latex. The thermoset could be foamed. Examples of thermoplastic materials include polypropylene, polypropylene copolymers, polystyrene, polyethylenes, ethylene vinyl acetates (EVAs), thermoplastic olefins (TPOs), thermoplastic polyester, thermoplastic vulcanizates (TPVs), polyvinyl chlorides (PVCs), chlorinated polyethylene, styrene block copolymers, ethylene methyl acrylates (EMAs), ethylene butyl acrylates (EBAs), and the like. The thermoset and/or thermoplastic material could be foamed. Further, the thermoset material could be elastomeric. The first cushioning component 48 and the second cushioning component 50 may be foamed from any material, including a thermoplastic or thermoset material, including any of these materials discussed above.

It may be desired to spatially distribute cushioning properties in the composite cushioning structure 46 in FIG. 3 that are different from the cushioning properties provided by the first cushioning component 48. In this regard, as an example, the first cushioning component 48 is provided as a block of height H₁, as illustrated in FIG. 3. The first cushioning component 48 is selected to provide certain desired deflection properties for a given load pressure. The second cushioning component 50 is provided in the composite cushioning structure 46. The second cushioning component 50 is also selected to provide certain desired deflection properties for a given load pressure, but different from the first cushioning component 48 in this example. The second cushioning component 50 is disposed within the first cushioning component 48 when in a liquid, gaseous, or plasma form such that the second cushioning component 50 is spatially distributed within the first cushioning component 48. In this regard, the second cushioning component 50 forms a cohesive or adhesive union with the first cushioning component 48 to provide the composite cushioning structure 46 with spatially variable properties of both the first and second cushioning components 48, 50. In this manner, the second cushioning component 50 can be distributed within the first cushioning component 48 in a spatially variable or non-uniform manner to form a GPF rather than providing the second cushioning component 50 as a separate stratum from the first cushioning component 48 wherein no portion of the second cushioning component 50 is disposed within the first cushioning component 48. The variability of distribution or density of the second cushioning component 50 can be controlled to customize the resultant properties of the GPF composite cushioning structure 46 that may not otherwise be possible by providing the second cushioning component 50 as a separate stratum from the first cushioning component 48.

For example, the first cushioning component 48 could be a thermoplastic material. The thermoplastic material could be selected to provide a high degree of stiffness to provide structural support for the composite cushioning structure 46. However, because the thermoplastic material may be prone to compression set over time and does not provide a soft feel to a load, the second cushioning component 50 could be provided as a thermoset precursor, as an example. The thermoset precursor, when in solid form, can provide an offset to compression set to counteract compression set occurring in the thermoplastic material while also exhibiting soft cushioning properties. Thus, the composite cushioning structure 46 in this example can be provided to exhibit both the desired cushioning properties of a thermoplastic material and a thermoset material.

In the example of the composite cushioning structure 46 in FIG. 3, the first cushioning component 48 is exclusively provided in the composite cushioning structure 46 where noted by “FCC,” meaning “first cushioning component.” This is a result of the second cushioning component 50 not being disposed into the entire height H₁ of the first cushioning component 48. The second cushioning component 50 is disposed into the top portion of the first cushioning component 48 noted by “FCC/SCC,” meaning “first cushioning component and second cushioning component.” The amount of the second cushioning component 50 disposed into the first cushioning component 48 in this region may be variable or gradiated to be uniform or non-uniform, or in an uneven manner, as desired, to provide GPF. A GPF composite cushioning structure is a two or more phase composite cushioning structure in which distribution of a second phase into a primary foam controls the local cushioning properties of the final composite cushioning structure.

In this regard in one embodiment, the density of the second cushioning component 50 disposed within the first cushioning component 48 can be varied to provide the desired cushioning properties from the composite to provide GPF, as desired. Also, the density of the second cushioning component 50 could be varied or controlled, as desired, to control the density of the second cushioning component 50 disposed within the first cushioning component 48 to provide the desired cushioning properties from the composite, as desired. Further, the second cushioning component 50 could also be disposed within the first cushioning component 48 such that the second cushioning component 50 is exclusively disposed on the top of the composite cushioning structure 46, as noted by “SCC,” meaning “second cushioning component,” in FIG. 3. Any combination or permutation of these features and characteristics may be provided in a composite cushioning structure.

After initial disposition of the second cushioning component 50 within the first cushioning component 48, the second cushioning component 50 will undergo a transition into a solid form, thereby forming a cohesive or adhesive union with the first cushioning component 48, as illustrated in FIG. 3. Because of the ability to variably control the distribution or density of the second cushioning component 50 in FIG. 3, the resultant properties of the composite cushioning structure 46 can be provided as desired that may not otherwise be possible by providing the second cushioning component 50 as a separate stratum. Advantages in this example include, but are not limited to, compression recovery, reduced weight, fewer layers of cushioning material, less labor in assembly, smaller form factor of the cushioning structure, less inventory, and/or antimicrobial features.

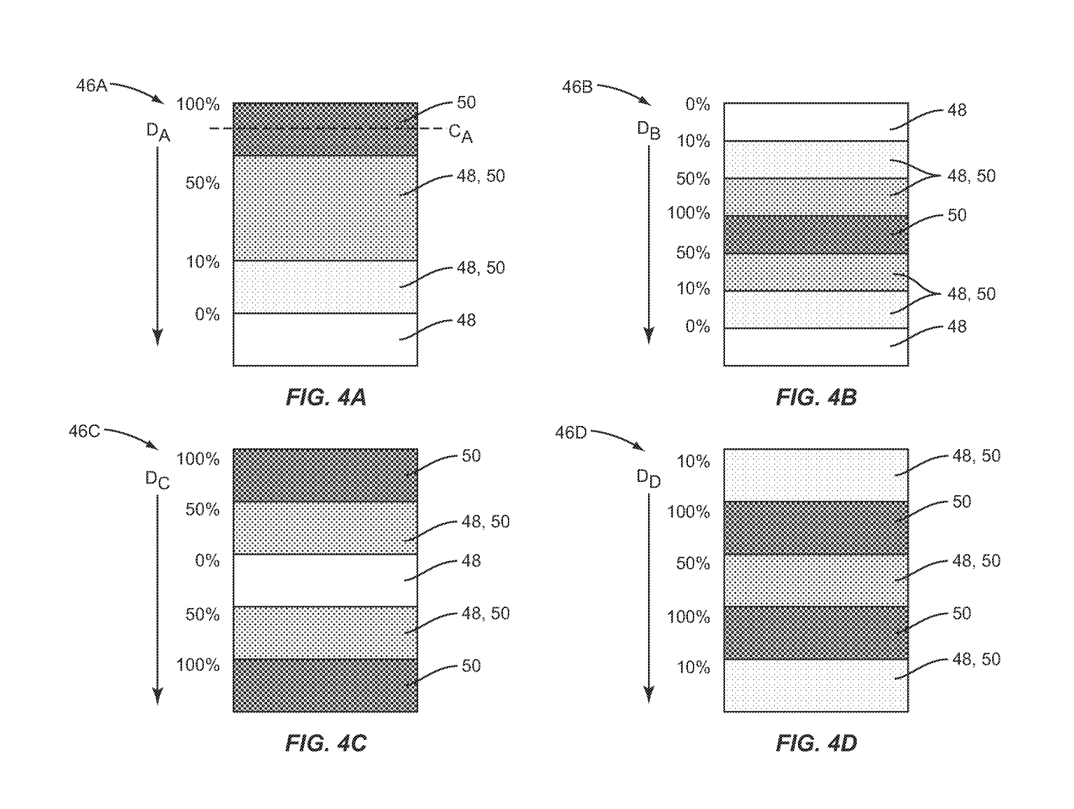

FIGS. 4A-4D illustrate other possibilities, as examples, of composite cushioning structures 46 that have spatially varying or variable distributions of the second cushioning component 50 in the first cushioning component 48. Spatially varying or providing spatially variable distributions of the second cushioning component(s) is where the amount of mass of the second cushioning component(s) spatially varies over a given line, area, or space in any number of dimensions. This can be advantageous in controlling the cushioning characteristics contribution of the second cushioning component(s) to the composite cushioning structure to further provide spatially varying cushioning characteristics in the composite cushioning structure. For example, it may be desired to provide different or varying cushioning characteristics in a composite cushioning structure in different areas, depths, volumes, etc. Spatial variable or spatially varying can be expressed in different exemplary manners. For example, it can be expressed as mass density. For example, if the second cushioning component(s) is disposed in a foam solid phase, the density of the second cushioning component(s) may be 0.5 ft./lbs.³ to 80 ft./lbs.³, and anywhere in between. As another example, if the second cushioning component(s) is disposed in a non-cellular phase, the density of the second cushioning component(s) may be up to 300 ft./lbs.³. Spatial variable or spatially varying can also be expressed as a fraction of free volume in the first cushioning component phase consumed by the second cushioning component(s), with the maximum being 100% and 0.1%, for example, representing a thin deposited layer.

In this regard for example, as illustrated in FIG. 4A, a composite cushioning structure 46A is provided that includes at least four (4) different gradients or densities of the second cushioning component 50 to the first cushioning component 48. Thus, the gradient of the second cushioning component 50 to the first cushioning component 48 spatially varies or is variable in the composite cushioning structure 46A, as opposed to a single, non-variable or non-varying density of the second cushioning component 50 to the first cushioning component 48 being present in the composite cushioning structure 46A. For example, the percentage density or volume of the second cushioning component 50 disposed in the first cushioning component 48 is spatially varied throughout at least a portion of the first cushioning component 48 and thus the composite cushioning structure 46A. The percentage density or volume of the second cushioning component 50 disposed in the first cushioning component 48 at specific points in the composite cushioning structure 46A is shown to the left of the composite cushioning structure 46A in FIG. 4A.

As illustrated in FIG. 4A, the gradient or density of the second cushioning component 50 in the composite cushioning structure 46A is initially composed of one-hundred percent (100%) of the second cushioning component 50. In a depth direction D_{A}, the gradient or density of the second cushioning component 50 in the composite cushioning structure 46A spatially decreases with the presence and increase in the first cushioning component 48 present in the composite cushioning structure 46A. For example, where the fifty percent (50%) transition line is shown in FIG. 4A, this means that at this location in the composite cushioning structure 46A, the composite cushioning structure 46A is composed of a fifty percent (50%) gradient or density of the first cushioning component 48 and a fifty percent (50%) gradient or density of the second cushioning component 50. Also for example, where the ten percent (10%) transition line is shown in FIG. 4A, this means that at this location in the composite cushioning structure 46A, the composite cushioning structure 46A is composed of ten percent (10%) gradient or density of the second cushioning component 50 and ninety percent (90%) gradient or density of the first cushioning component 48. Thus, as shown in FIG. 4A, the gradient or density of the first cushioning component 48 to the second cushioning component 50 can be spatially varied throughout or in a portion of the composite cushioning structure 46A.

Note that FIG. 4A appears to illustrate clear delineations or distinct transitions between different gradients or densities of the second cushioning component 50 to the first cushioning component 48. However, it is understood that these transitions can be provided as gradual, smooth transitions if desired. For example, the delineations or transitions shown in FIG. 4A may indicate a ratio of gradients or densities of the second cushioning component 50 to the first cushioning component 48 only at that particular point. For example, the gradient or density of the second cushioning component 50 to the first cushioning component 48 may vary from one-hundred percent (100%) to fifty percent (50%) in intermediate gradients or densities between such transitions. The same is possible between the other transitions in the composite cushioning structure 46A in FIG. 4A.

The gradient or density of the second cushioning component 50 to the first cushioning component 48 can spatially vary uniformly or linearly as a function of distance between transitions in the composite cushioning structure 46A or non-uniformly as a function of distance between transitions in the composite cushioning structure 46A. An example of spatially uniform change in gradient or density in the composite cushioning structure 46A in FIG. 4A would be to find that the gradient or density of the second cushioning component 50 to the first cushioning component 48 at the center line C_{A} in FIG. 4A is seventy-five percent (75%) of the second cushioning component 50 to twenty-five percent (25%) of the first cushioning component 48. An example of spatially non-uniform change in gradient or density in the composite cushioning structure 46A in FIG. 4A would be to find that the gradient or density of the second cushioning component 50 to the first cushioning component 48 at the center line C_{A} in FIG. 4A is sixty percent (60%) of the second cushioning component 50 to forty percent (40%) of the first cushioning component 48.

FIGS. 4B-4D illustrate other examples of composite cushioning structures 46B, 46C, 46D, respectively, that include different gradients or densities of the second cushioning component 50 to the first cushioning component 48. As illustrated in FIG. 4B, the gradient or density of the second cushioning component 50 in the composite cushioning structure 46B is initially composed of zero percent (0%) of the second cushioning component 50. In a depth direction D_{B}, the gradient or density of the first cushioning component 48 in the composite cushioning structure 46B spatially decreases with the presence and increase in the second cushioning component 50 present in the composite cushioning structure 46B. For example, where the first ten percent (10%) transition line 47 is shown in FIG. 4B, this means that at this location in the composite cushioning structure 46B, the composite cushioning structure 46B is composed of a ten percent (10%) gradient or density of the second cushioning component 50 and a ninety percent (90%) gradient or density of the first cushioning component 48. Also for example, where the first fifty percent (50%) transition line 49 is shown in FIG. 4B, this means that at this location in the composite cushioning structure 46B, the composite cushioning structure 46B is composed of a fifty percent (50%) gradient or density of the first cushioning component 48 and a fifty percent (50%) gradient or density of the second cushioning component 50. Thus, as shown in FIG. 4B, the gradient or density of the first cushioning component 48 to the second cushioning component 50 can be spatially varied throughout or in a portion of the composite cushioning structure 46B. In the composite cushioning structure 46B of FIG. 4B, the gradient or density of the second cushioning component 50 increases and then decreases in the depth direction D_{B}, unlike the composite cushioning structure 46A in FIG. 4A.

Just as provided in the composite cushioning structure 46A in FIG. 4A, the gradient or density of the second cushioning component 50 to the first cushioning component 48 in the composite cushioning structures 46B, 46C, 46D in FIGS. 4B-4D can spatially vary uniformly or linearly as a function of distance between transitions in the composite cushioning structure 46A or non-uniformly as a function of distance between transitions in the composite cushioning structure 46A. The composite cushioning structure 46B in FIG. 4B has a gradient of the second cushioning component 50 that is initially zero percent (0%) and then increases to one hundred percent (100%) and then decreases in the depth direction D_{B} to zero percent (0%). The composite cushioning structure 46C in FIG. 4C has a gradient of the second cushioning component 50 that is initially one hundred percent (100%) and then decreases to zero percent (0%) and then increases to one hundred percent (100%) in a depth direction D_{c}. The composite cushioning structure 46D in FIG. 4D has a gradient of the second cushioning component 50 that is initially ten percent (10%) and then increases and decreases in an alternating fashion in a depth direction D_{D}.

Just as provided and discussed above for the composite cushioning structure 46A in FIG. 4A, the gradient or density of the second cushioning component 50 to the first cushioning component 48 in the composite cushioning structures 46B, 46C, 46D in FIGS. 4B-4D can spatially vary uniformly or linearly as a function of distance between transitions in the composite cushioning structures 46B, 46C, 46D or non-uniformly as a function of distance between transitions in the composite cushioning structures 46B, 46C, 46D.

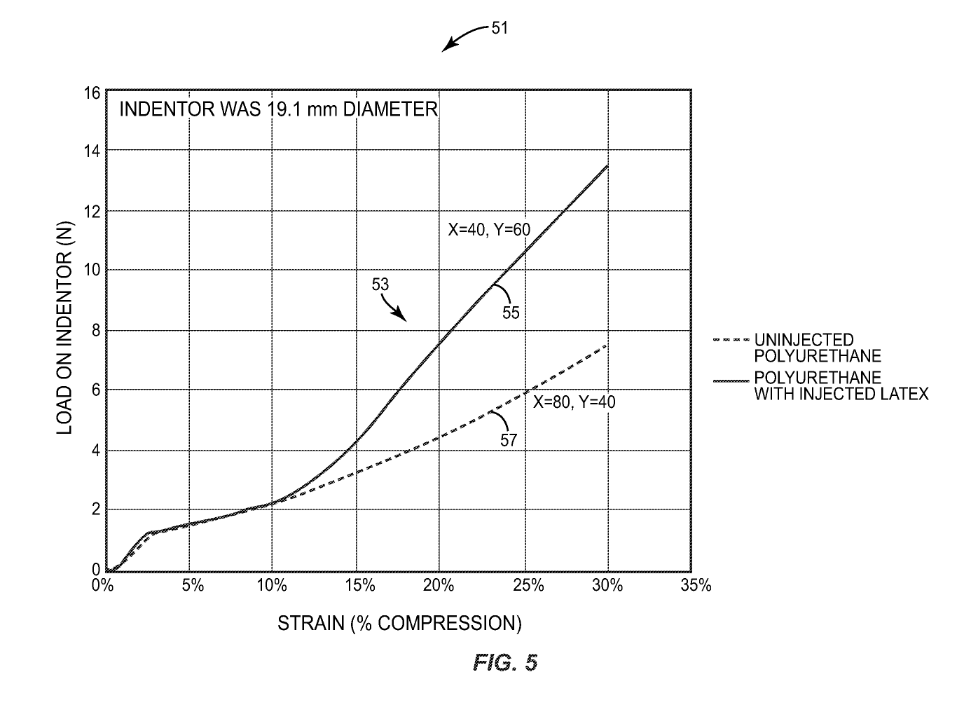

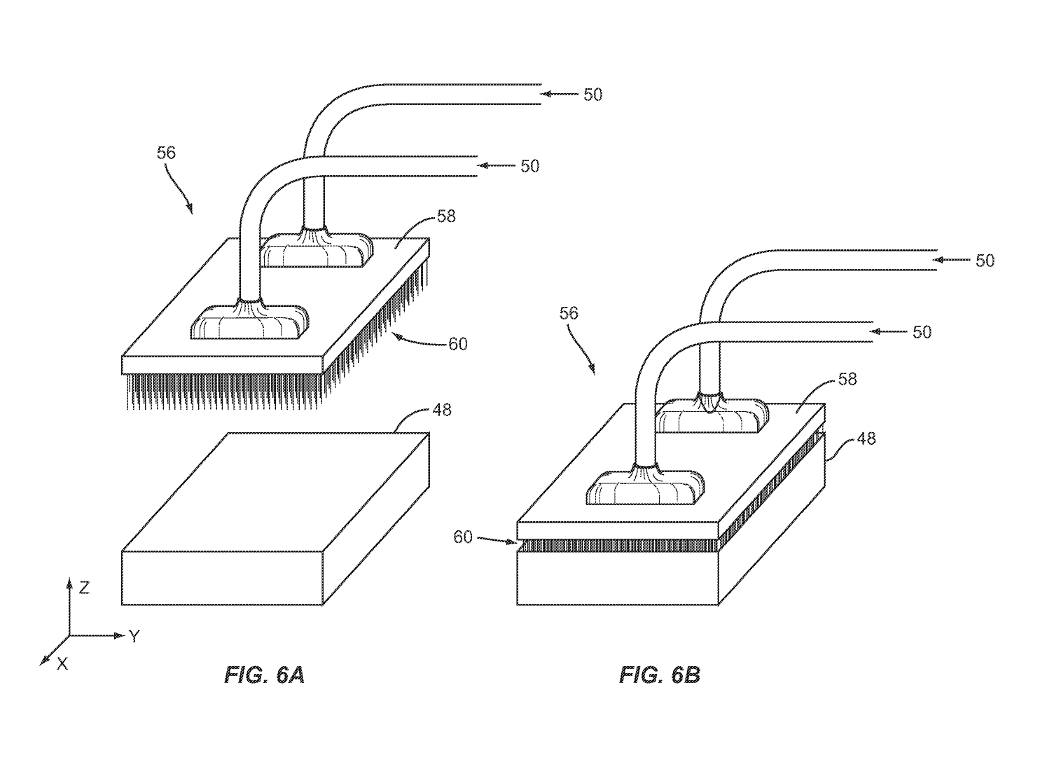

FIG. 5 is a chart 51 of exemplary performance curves showing load deflection curves 53 from two regions of a composite cushioning structure having a second cushioning component of latex injected into a first cushioning component of open-cell polyurethane foam to provide gradient property foam. The deflection in a first region where the latex was injected into the first cushioning component is represented by curve 55. The deflection in a second region where the latex was not injected into the first cushioning component is represented by curve 57. The X and Y coordinates in the chart 51 refer to the actual physical location of the composite cushioning structure where the deflection measurement was made. As can be seen from the chart 51, the deflection for a given load or pressure of the polyurethane foam without latex present is represented by the curve 57. When latex is injected, the deflection characteristics of the polyurethane foam can be altered as desired. This is represented by the curve 55 where the injection of latex changes the deflection characteristics of the polyurethane foam. In this example, the presence of latex requires a greater pressure or load to produce the same strain as provided by polyurethane foam not injected with latex. There are different processes that can be employed to spatially distribute the second cushioning component 50 in the first cushioning component 48 in FIGS. 3 and 4A-4D to form GPF. For example, FIGS. 6A and 6B illustrate one exemplary controlled injection process. In this process, an injection machine 56 is provided. The injection machine 56 is comprised of a platform 58 that supports a linear or planar array of hollow injection needles 60 disposed in one or more dimensions that are configured to inject the second cushioning component 50 in liquid, gaseous, or plasma form into the first cushioning component 48. FIG. 6A illustrates the injection machine 56 before the hollow injection needles 60 are disposed in the first cushioning component 48. FIG. 6B illustrates the injection machine 56 after the hollow injection needles 60 are injected into the first cushioning component 48. When injected, the injection machine 56 can control the hollow injection needles 60 to the desired depth of the first cushioning component 48 to inject the second cushioning component 50 into the first cushioning component 48 to create the composite cushioning structure 46. For example, the hollow injection needles 60 can be disposed to the “FCC/SCC” “FCC” interface in the first cushioning component 48, as illustrated in FIG. 3.

As the hollow injection needles 60 are withdrawn from the first cushioning component 48, the non-solid phase of the second cushioning component 50 is pumped into the first cushioning component 48. By varying either the flow rate of the second cushioning component 50 pumped out of the hollow injection needles 60 or the rate at which the hollow injection needles 60 are withdrawn from the first cushioning component 48, the concentration of the second cushioning component 50 can be varied in the Z-direction, as illustrated in FIGS. 6A and 6B. The flow rates of individual hollow injection needles 60 could also be varied to vary the concentration of the second cushioning component 50 in the first cushioning component 48 in the Y-direction and X-direction as well. This would be possible, for example, by providing individually indexed hollow injection needles 60 or sub-arrays of hollow injection needles 60.

This technique is not limited to creating monotonic distributions. It could, for example, produce a composite cushioning structure 46 that has a low concentration of the first cushioning component 48 on the top and bottom of the composite cushioning structure 46 and a high concentration of the second cushioning component 50 in the middle of the composite cushioning structure 46, or the reverse—a high concentration of the first cushioning component 48 in the middle of the composite cushioning structure 46 and a low concentration of the second cushioning component 50 at the top and bottom of the composite cushioning structure 46. Variations of the second cushioning component within the first cushioning component in the Y-direction could be similarly produced.

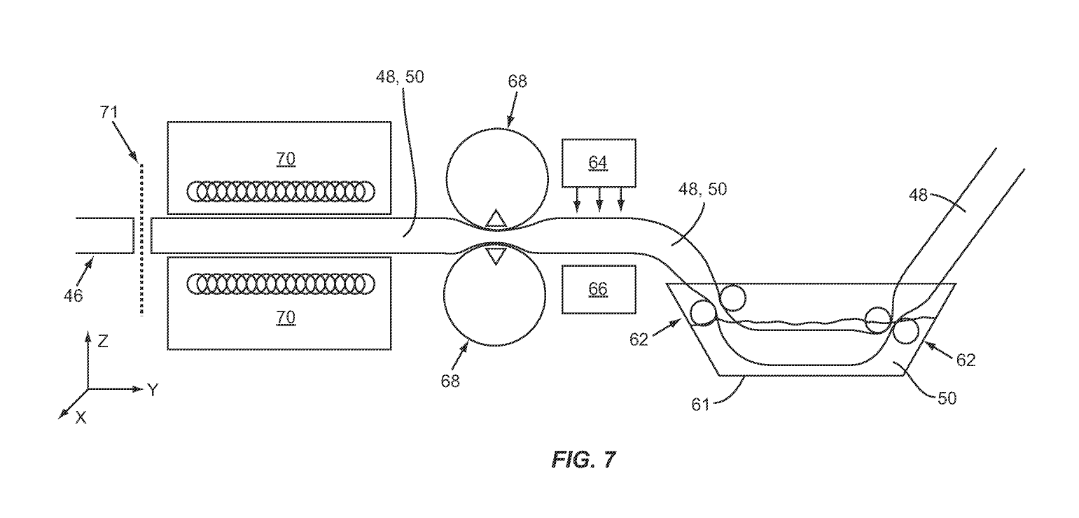

Another process for providing a spatially variable distribution of the second cushioning component 50 into the first cushioning component 48 to form GPF is by an infusion-blowing process. An example of an infusion-blowing process is illustrated in FIG. 7. The infusion-blowing process can be done in a subtractive or additive manner. As illustrated in FIG. 7, the non-solid form of the second cushioning component 50 is disposed in a bath 61. The first cushioning component 48 is introduced to the bath 61, and thus the second cushioning component 50, and is partially wrung out by compression, extraction rollers 62 in a centrifugation method. Thereafter, the first cushioning component 48 soaked in the second cushioning component 50 is disposed under a blowing head 64. Optionally, a vacuum head 66 is placed against the surface of the first cushioning substrate 48. This airflow through the porous structure of the first cushioning component 48 acts to redistribute the non-solid phase of the second cushioning component 50 in the first cushioning component 48 to variably spatially distribute the second cushioning component 50 in the first cushioning component 48.

This process variant is subtractive, because the variability is produced by removing some amount of the second cushioning component 50 from the first cushioning component 48. Thereafter, the first cushioning component 48 soaked in the second cushioning component 50 is disposed through a perforated roller 68 and disposed through an oven 70 to transform the second cushioning component 50 into solid form to form the composite cushioning structure 46. The composite cushioning structure 46 can thereafter be cut by cutters 71.

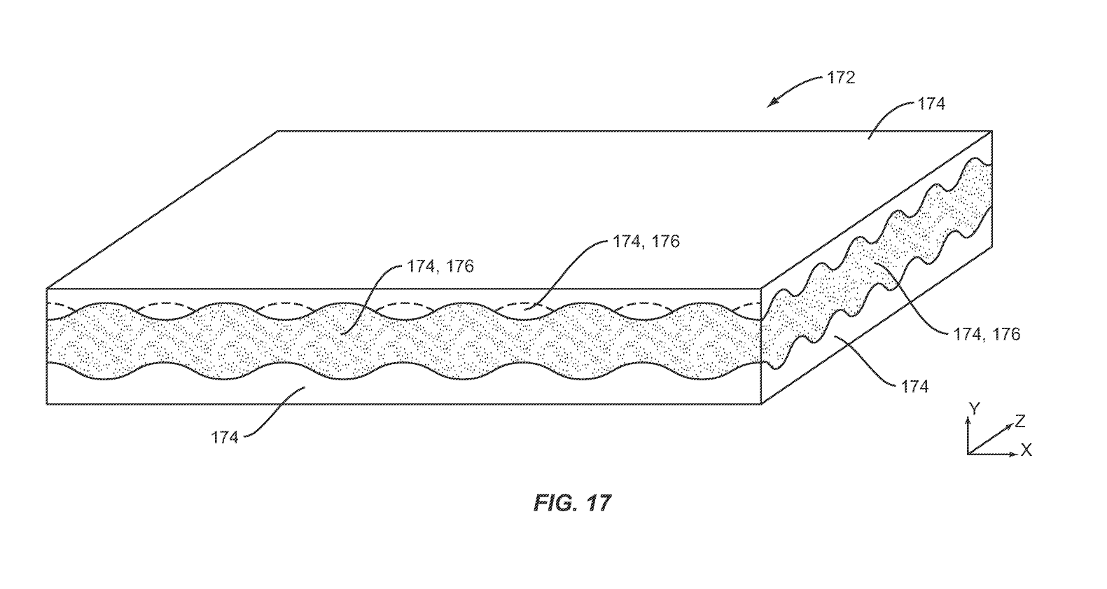

Alternatively, additive infusion-blowing uses the airflow from the blowing head 64 not only to distribute the non-solid phase of the second cushioning component 50, but also to introduce it to the first cushioning component 48. This variation of the process skips the infusion bath step discussed above and illustrated in FIG. 17. Each blowing head 64 would also contain a delivery system to deliver the second cushioning component 50 to the first cushioning component 48.

The infusion-blowing process could be continuous. By varying the air flow, smoothly varying densities and gradients of the second cushioning component 50 disposed in the first cushioning component 48 could be provided in the X- and Z-directions as well. Multiple blowing heads across the Y-direction could be individually controlled to provide variation of the second cushioning component 50 disposed in the first cushioning component 48 in the Y-direction as well.

Another process for providing a spatially variable distribution of the second cushioning component 50 into the first cushioning component 48 is by an infusion-centrifugation. Infusion-centrifugation is a batch process in which the porous first cushioning component 48 is event infused with a non-solid phase of the second cushioning component 50. Then, a portion of the first cushioning component 48 is spun in a centrifuge to redistribute the non-solid phase of the second cushioning component 50 into the first cushioning component 48. The initial infusion can be provided by compressing and releasing the first cushioning component 48 while it is immersed in a bath of the non-solid second cushioning component 50. A further set of wringer rollers can be employed to remove the excess second cushioning component 50 by controlling the compression in the wringing step. The quantity of the remaining second cushioning component 50 can be set. The acceleration imposed during centrifugation can concentrate the second cushioning component 50 near the bottom surface of the first cushioning component 48.

Further, a vacuum infusion process could be used to introduce a fluid second cushioning component 50 into the porous first cushioning component 48. It may also be possible to use the differences in air pressure found in this process to distribute a fluid phase of the second cushioning component 50 in the first cushioning component 48 in a spatially variable manner. Because of the need for sealed chambers, the vacuum process is necessarily a batch process.

Consider a three-chamber system in which the chambers are connected in series by airlocks. A section of the substrate of the first cushioning component 48 is loaded into a first chamber. It is sealed and the air is pumped out of it. The airlock to an already-evacuated second chamber opens, and the substrate of the first cushioning component 48 moves into this chamber. After the second chamber seals, nozzles apply the second cushioning component 50 fluid phase to the upper surface of the first cushioning component 48. The relative surface tensions of the first cushioning component 48 and the liquid phase of the second cushioning component 50 will control the speed and depth of penetration of the second cushioning component 50 into the first cushioning component 48. The vapor pressure of the liquid phase of the second cushioning component 50 at the temperature of the second chamber will control the evaporation or boiling of the liquid or some of its components.

The airlock between the second chamber and an evacuated third chamber now opens and the second cushioning component 50 loaded first cushioning component 48 (i.e., the composite cushioning structure 46 with the second cushioning component 50 in liquid form), moves into the third chamber. The airlock between the second and third chambers closes. In the third chamber is a horizontal perforated plate that divides the lower part of the chamber containing the composite cushioning structure 46 from the upper part of the chamber, which is an open manifold. The composite cushioning structure 46 is moved vertically such that it is in contact with the plate. At this time, air or some other gas is let into the upper manifold at a controlled rate. In order to equalize pressure in the lower portion of the third chamber, the gas must pass through the holes in the plate and through the porous first cushioning component 48. This flow will induce movement of the liquid phase of the second cushioning component 50 through the porous first cushioning component 48.

A particular pattern of spatial variation of the second cushioning component 50 could be produced by selecting the pattern and size of perforations in the plate, the rate of gas introduction, the size and tortuosity of the substrate porosity of the first cushioning component 48, and the viscosity of the liquid phase of the second cushioning component 50. After pressure is equalized, the final airlock is opened and the part is removed. Additionally, in a practical process, a subsequent section of substrate of the first cushioning component 48 will be loaded into the first chamber and be evacuated while the previous section is in the second chamber having the liquid of the second cushioning component 50 applied. The overall speed of the process will thus correspond to the speed of the slowest of the three steps.

Further, vacuum infusion alone could be used in conjunction with another redistributive batch process such as centrifugation. In this case it would take the place of the bath with wringer rollers. This would be advantageous in the case of a rigid substrate that could not recover from crushing.

Further, if the second cushioning component 50 is plasma, another process that can be employed for providing a spatially variable distribution of the second cushioning component 50 into the first cushioning component 48 is a plasma-based polymer deposition process.

In another embodiment, the liquid phase of the second cushioning component 50 could be thermally liquefied (i.e., melted). The process temperature of the liquefied phase may be controlled to be below the temperature at which the open-celled foam substrate of the first cushioning component 48 begins to break down. The melted liquefied phase of the second cushioning component 50 could be applied either by centrifugation or by injection, as examples, including by the processes and apparatuses discussed above. Non-limiting examples of material choices for the liquefied phase of the second cushioning component 50 could be low-melting polyolefin copolymers such as EVA, EMA, EBA, and m low-density polyethylene (LDPE) (mLDPE) as non limiting examples. Injection of the melted liquefied phase of the second cushioning component 50 could be employed to create “fingers” of the resilient thermoplastic elastomer (TPE), which would be supported by the surrounding matrix of open-celled foam. The volume and/or height of the “fingers” could be varied across the composite cushioning structure 46 to form GPF to create two-dimensional and three-dimensional zones in the composite cushioning structure 46 with different cushioning properties, as previously discussed.

Some experiments with particular scrap suggest another method of creating the GPF composite cushioning structure, including the composite cushioning structure 46 discussed above. For example, scrap material in the form of closed-cell polyethylene/copolymer foam, PVC foam, foam rubber, stiffer polyurethane, or combinations or hybrids thereof as non-limiting examples may be used as the second cushioning component, including any of the second cushioning components 50 described above. As an exemplary process, the scrap may be chopped or ground to a desired particle size, for example 2.0 to 10.0 millimeters (mm). The same type of scrap material may be used if it is desired to maintain a consistent GPF composite cushioning structure. The production process may employ a pair of dispensers on an X-Y motion control system. One dispenser may be for the matrix foam phase for the first cushioning component. The other dispenser may be for the particular scrap for the second cushioning component. The dispensing heads could be controlled to travel alone and across the first cushioning component in a pattern, laying down a flow of matrix foam and a variable amount of scrap particulate. The particular delivery may be controlled such that certain preprogrammed regions of the first cushioning component may contain a higher density of scrap second cushioning component than others. The amount of the matrix foam first cushioning component delivery on a single pass may not be enough to fill the entire composite cushioning structure form—it may take several passes where scrap particulate is dispensed on each pass. The pattern of scrap particulate dispersion in each layer can be maintained or varied with each pass by varying the dispersion between layers as well as within layers. This method can be used to create three-dimensional GPF.

Other examples of scrap particulate second cushioning component(s) may be polyolefin closed-cell foam and elastomeric foam, such as PVC or rubber foams. The scrap foam may be comingled with other types. The particulate scrap foam may be mixed in slurry form with a reactive thermoset system, such as polyurethane, latex, or silicone as examples. The slurry may be accomplished in a batch drum apparatus and poured, pushed, or rammed into a first cushioning component.

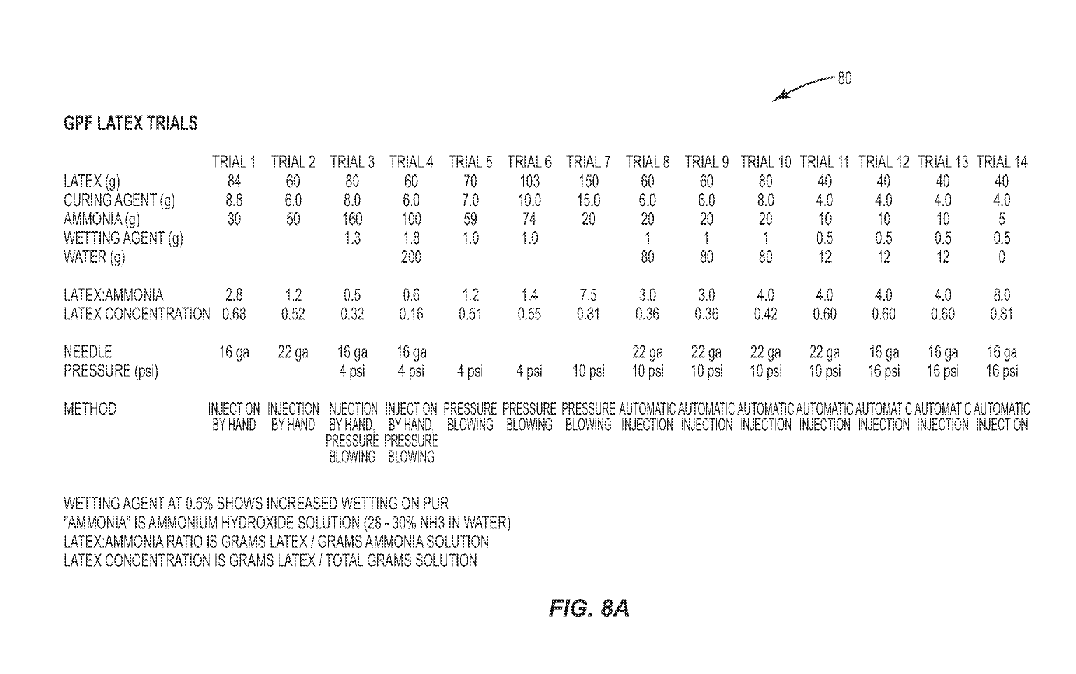

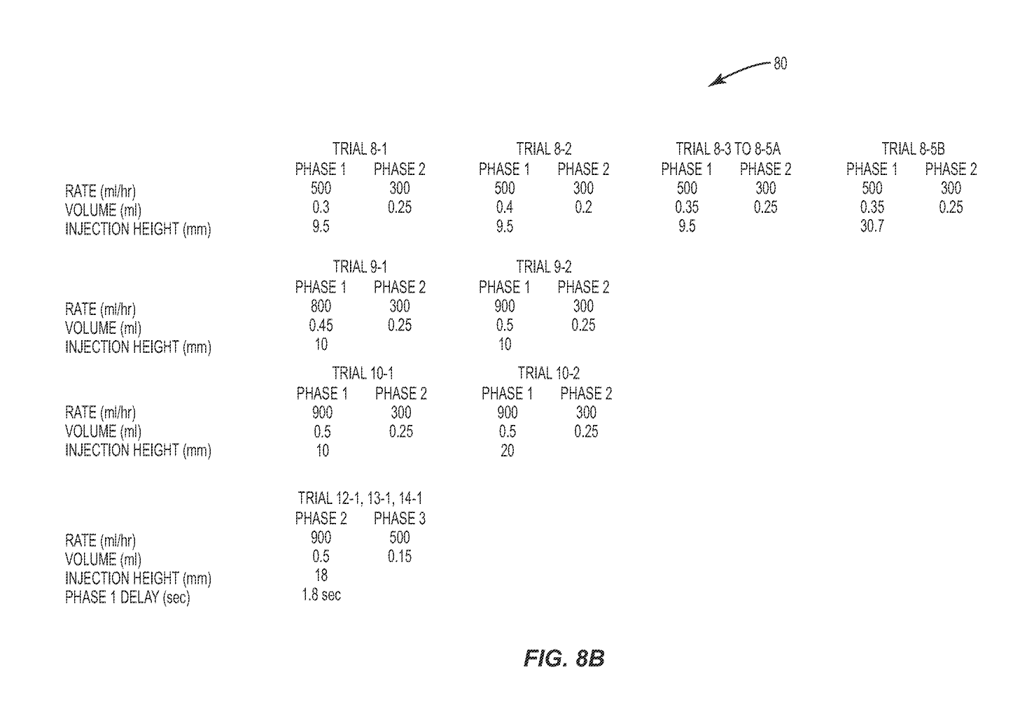

Several experiments were conducted on the creation and properties of examples of GPF. In this example, FIGS. 8A and 8B are a table 80 illustrating formulations used in trials of GPF based on various parameters, including equipment, pump speed, needle height, and volume of a latex injected into polyurethane foam. The table 80 sets forth fourteen (14) trials, labeled “Trial 1” through “Trial 14” with various components and parameters varied as set forth in the table 80. The trials in FIG. 8A set forth parameters used to carry out experimentations to produce exemplary formulations of a second cushioning component based on latex. The trials set forth in FIG. 8A experimented with variations in the amount of latex, curing agent, ammonia, wetting agent, and water to produce formulations. Further, the ratios of latex to ammonia and latex concentration to the formulation are set forth as noted in FIG. 8A. The gauge of the needle and pressure employed for the injection mechanism to test injecting the second cushioning component formulation are also set forth in FIG. 8A.

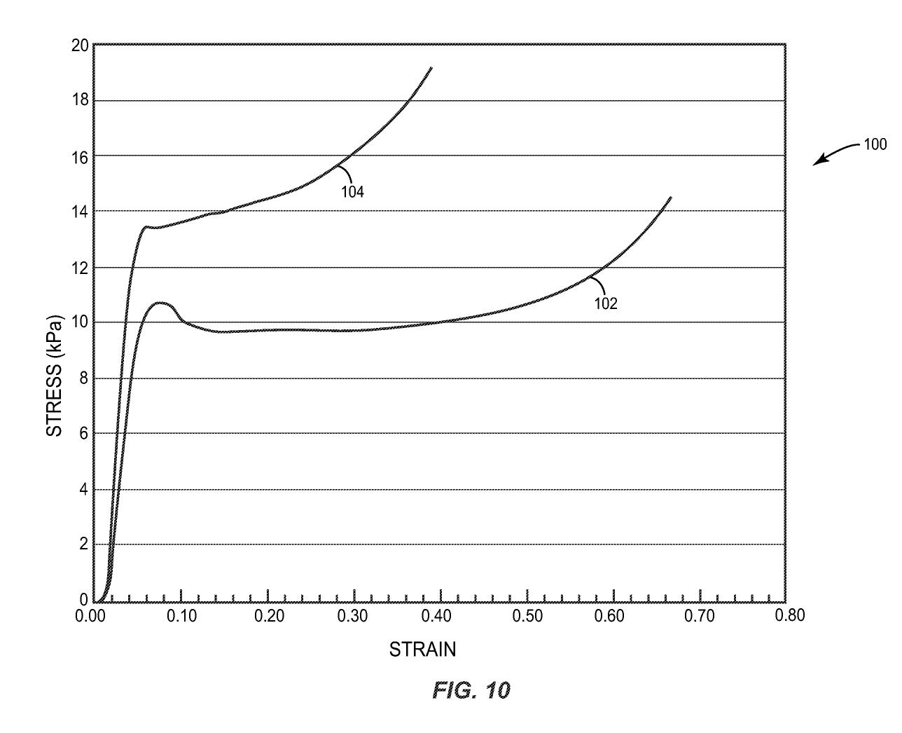

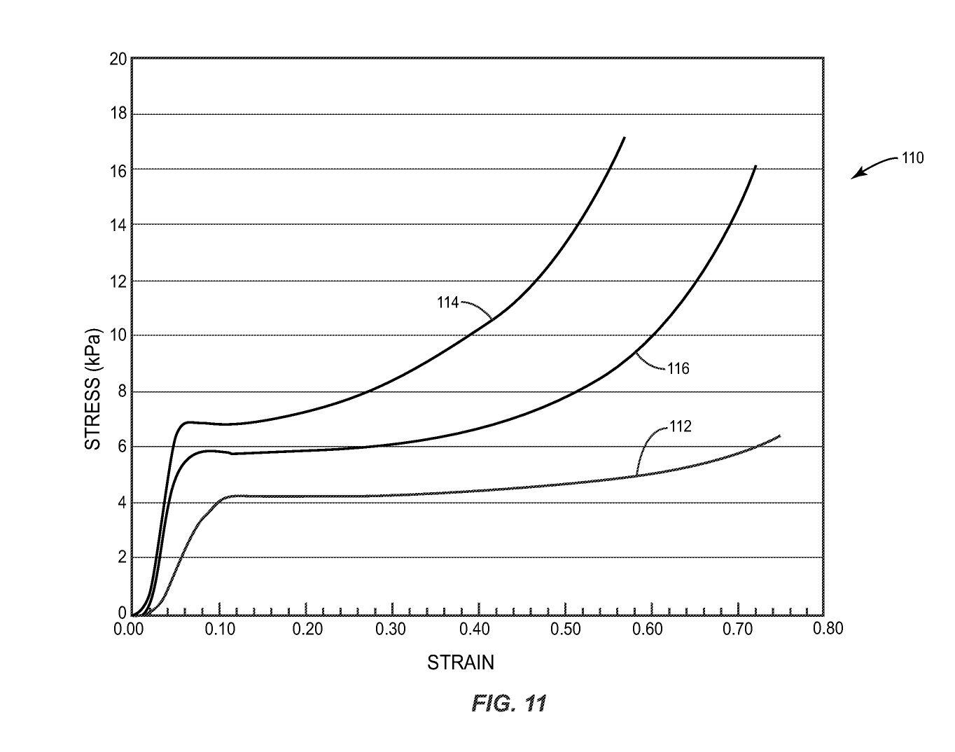

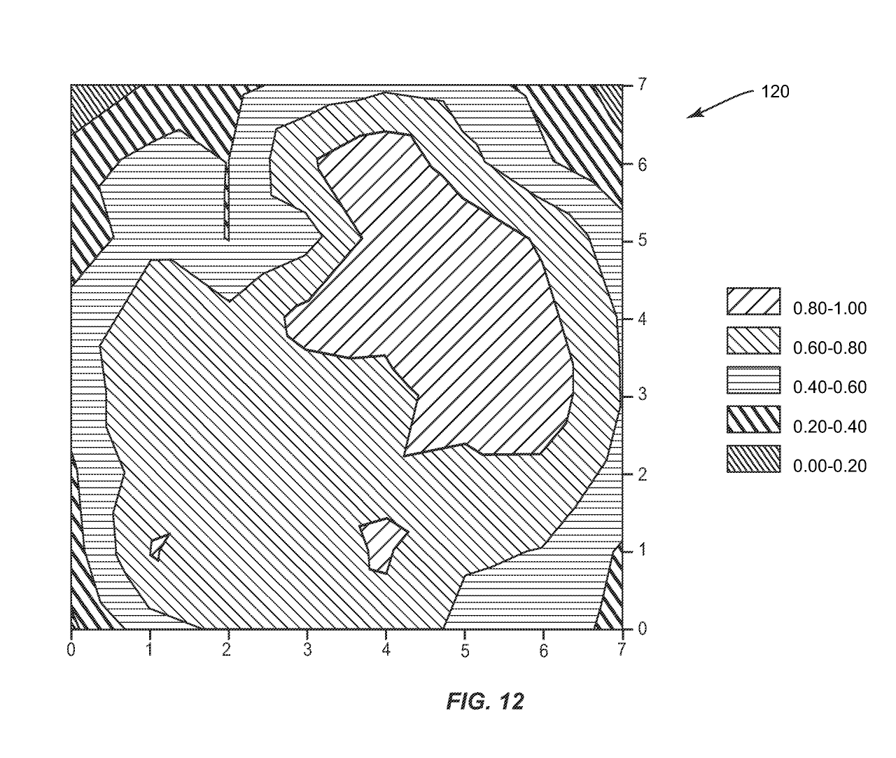

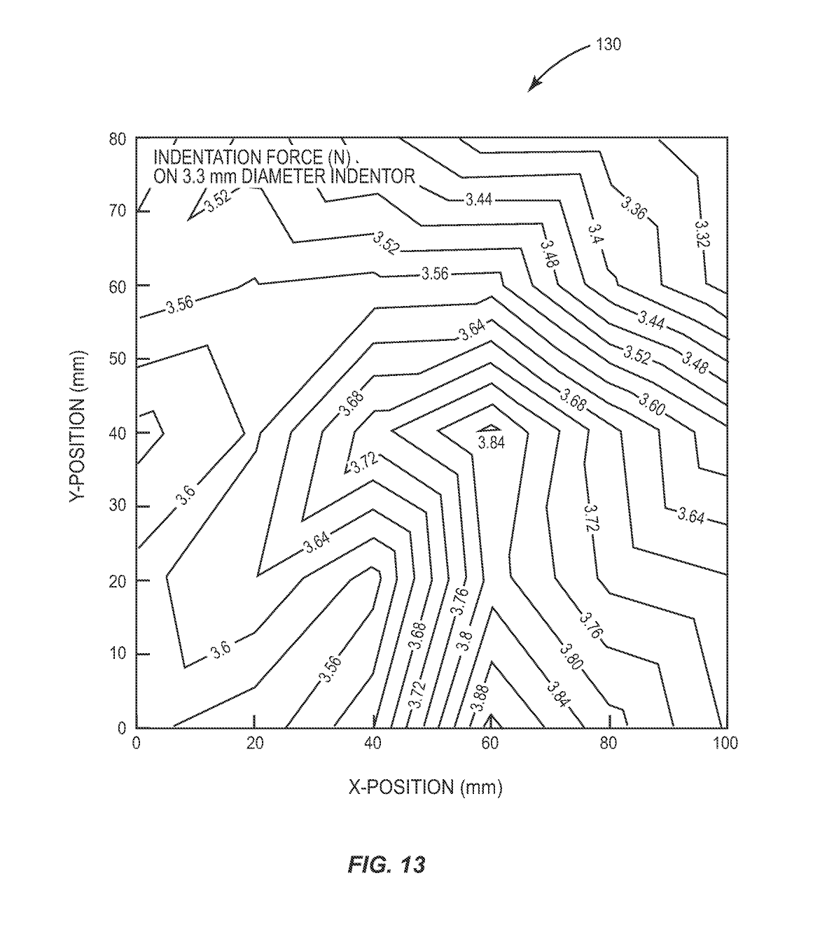

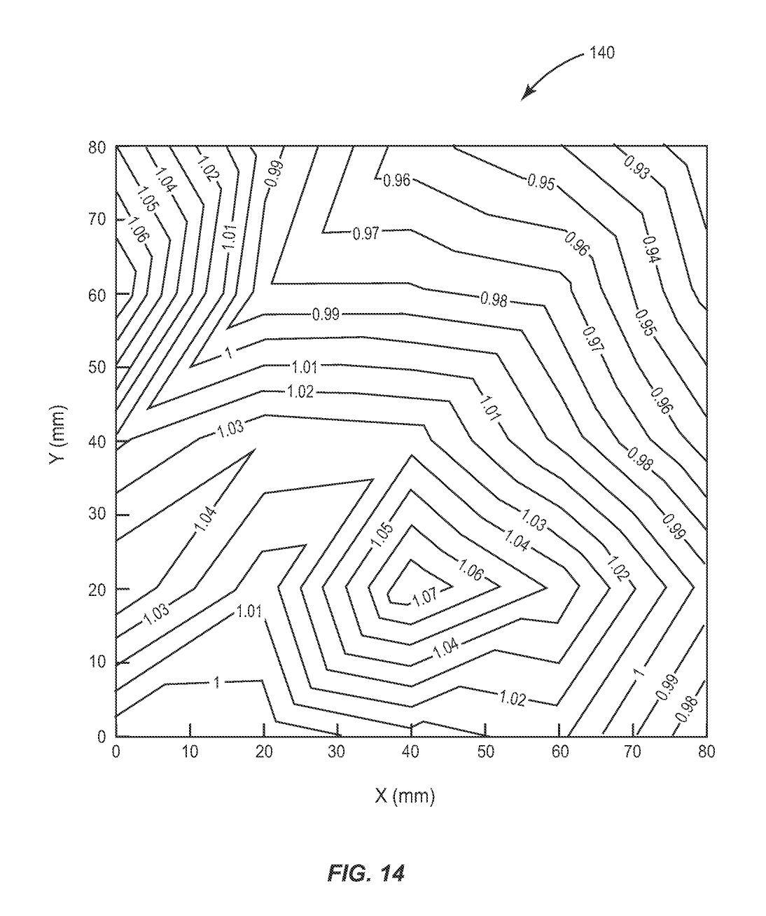

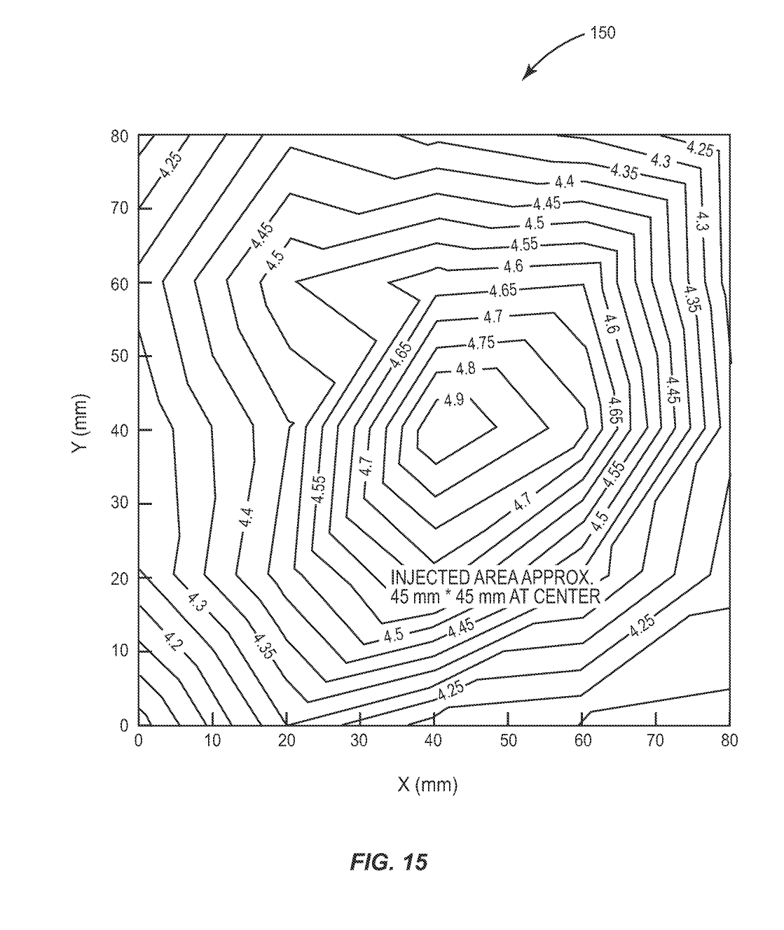

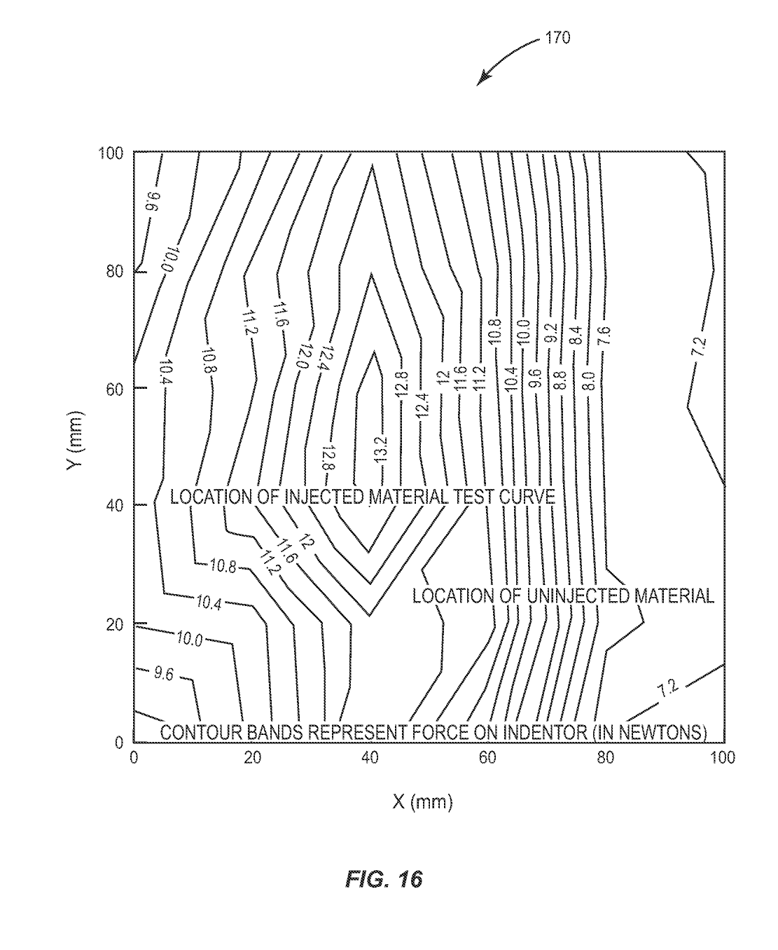

Trials 1-7 in FIG. 8A were conducted using a hand-held syringe, where the control of rate, depth, or quantity of the formulation injection was not precisely controlled. Trials 8-14 in FIG. 8A were conducted with automated equipment that controlled the rate, depth, and quantity of the formulation injection through a syringe. As discussed in more detail, the stress and strain characteristics of a composite cushioning structure employing the formulation in Trial 1 as the second cushioning component is represented by the chart 100 in FIG. 10. The stress and strain characteristics of a composite cushioning structure employing the formulation in Trial 1 as the second cushioning component without centrifuging are represented by the chart 110 in FIG. 11. The stress and strain characteristics of a composite cushioning structure employing the formulation in Trial 14 as the second cushioning component are represented by the chart 51 in FIG. 5. The stress and strain characteristics of a composite cushioning structure employing the formulation in Trial 7 as the second cushioning component are represented by the chart 120 in FIG. 12. The stress and strain characteristics of a composite cushioning structure employing the formulation in Trial 8 as the second cushioning component are represented by the chart 130 in FIG. 13. The stress and strain characteristics of a composite cushioning structure employing the formulation in Trial 10 as the second cushioning component are represented by the chart 140 in FIG. 14. The stress and strain characteristics of a composite cushioning structure employing the formulation in Trial 13 as the second cushioning component are represented by the chart 150 in FIG. 15. The stress and strain characteristics of a composite cushioning structure employing the formulation in Trial 14 as the second cushioning component are represented by the chart 160 in FIG. 16.

The purpose of the wetting agent in these formulations experiments in FIG. 8A is to lower the surface tension of a liquid such that it wets and spreads to a greater extent on an incompatible surface of a first cushioning component or partially-compatible surface of a first cushioning component. For example, it may be desired to introduce a liquid phase of the second cushioning component formulation to spread over the surface of the first cushioning component rather than clumping in a few pores.

The trials in FIG. 8B are experimentations of injection rates, volumes, and injection height of the formulations in FIG. 8A. The formulation in FIG. 8A used in an experimentation in FIG. 8B are set forth with the same prefix number, with the suffix being the trial number with such formulation. For example, “Trial 8-1” is the first trial with formulation number 8 in FIG. 8A. “Trial 9-2” is the second trial with formulation number 9 in FIG. 8A.

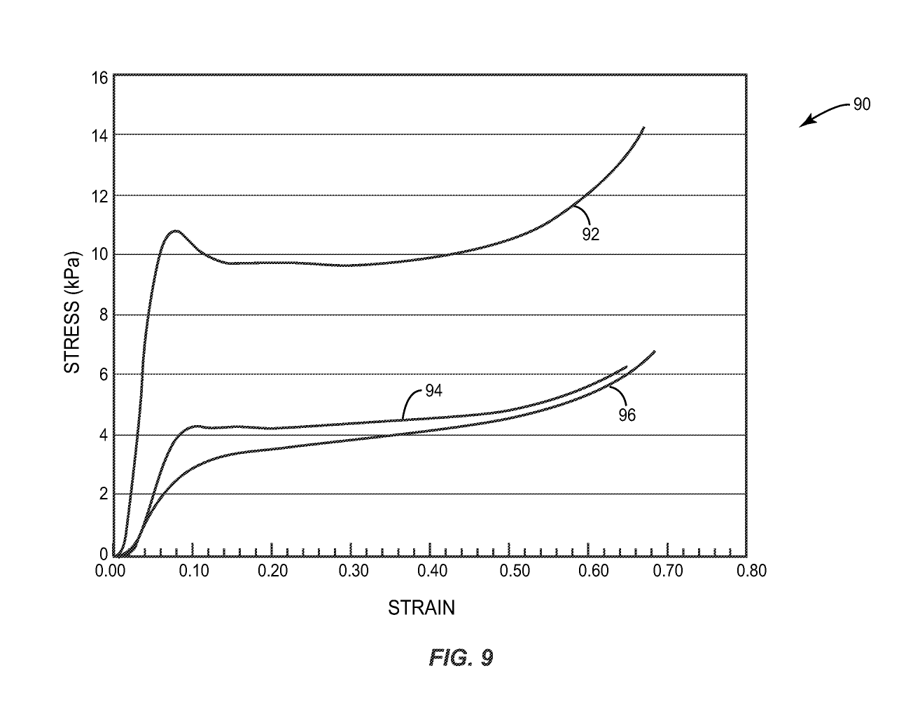

FIG. 9 is a chart 90 illustrating compressive stress-strain response of open-cell polyurethane foam without a second cushioning component(s) disposed therein to provide GPF based observations from experimentation and testing for comparison purposes. Curve 92 in FIG. 9 illustrates compressive stress-strain response of a first stiff polyurethane foam. Curve 94 in FIG. 9 illustrates compressive stress-strain response of a second less stiff polyurethane foam. Curve 96 in FIG. 9 illustrates compressive stress-strain response of the least stiff polyurethane foam among those represented by curves 92, 94, 96.

As another example, FIG. 10 is a chart 100 illustrating compressive stress-strain response of open-cell polyurethane foam before and after being centrifuged with latex to provide GPF based observations from experimentation and testing for comparison purposes. Curve 102 in FIG. 10 illustrates compressive stress-strain response of the polyurethane foam prior to being centrifuged with latex to provide GPF. Curve 104 in FIG. 10 illustrates the modified compressive stress-strain response of response of the polyurethane foam when centrifuged with latex in two examples to provide GPF. Notice that the compressive stress-strain response of the GPF provided by the centrifuged latex into the polyurethane foam represented by the curve 102 is stiffer and appears to have a higher support factor than the non-centrifuged polyurethane foam.

As another example, FIG. 11 is a chart 110 illustrating compressive stress-strain response of open-cell polyurethane foam before and after being injected with latex to provide GPF based observations from experimentation and testing for comparison purposes. Curve 112 in FIG. 11 illustrates compressive stress-strain response of the polyurethane foam prior to being injected with latex to provide GPF. Curves 114 and 116 in FIG. 11 illustrate the modified compressive stress-strain response of response of the polyurethane foam when injected with latex in two examples to provide GPF. Notice that the compressive stress-strain response of the GPF provided by the injected latex in to the polyurethane foam represented by curves 114 and 116 are stiffer and appear to have a higher support factor than the non-injected polyurethane foam.

As another example, FIG. 12 is a window chart 120 illustrating data from an experiment conducted by use of pressurized air to distribute latex as a second cushioning component into a polyurethane foam as a first cushioning component to provide GPF. The fixture to create the GPF in this example of FIG. 12 was provided by strategically blocking some of the air flow of the pressured air source to provide a stripe pattern of high and low density GPF in the composite structure. The window chart 120 shows the outcome of a matrix of indentation tests conducted across the surface of the composite structure. The units illustrated in the window chart 120 are in terms of fraction of the maximum load measured on the composite structure: Result (n)=Load (n)/Maximum Load, yielding a value between 0 and 1.0, as illustrated in the window chart 120.

Further experimentation was conducted by testing of a latex centrifuged polyurethane foam to provide a GPF sample, as illustrated in Table 1 below. The sample was sliced into layers corresponding to different depths in the sample. Layer 1 was the uppermost surface, and layer 4 was the lowermost surface. Table 1 shows that the latex was redistributed from the upper portion of the sample to the lower layers, as there is a continuous increase in density from top to bottom, separated by roughly a factor of two.

TABLE 1
Local density of GPF sample (layers)
Small-scale-IFD (units of N) and Support Factor

| | IFD-25% | | IFD-65% | S. Factor | |
|---|---|---|---|---|---|
| Control | 22.5 | | 53.9 | 2.5 | |
| GPF | 34.9 | | 119.1 | 3.4 | |
| | mass | I | w | | density |
| Sample | (g) | (mm) | (mm) | h (mm) | (Kg/m\hat{ }3) |
| layer 1 | 12.46 | 182.0 | 78.0 | 25.0 | 35.1 |
| layer 2 | 14.89 | 182.0 | 78.0 | 25.0 | 42.0 |
| layer 3 | 16.98 | 182.0 | 78.0 | 25.0 | 47.8 |
| layer 4 | 30.92 | 182.0 | 78.0 | 30.0 | 72.6 |

FIG. 13 is an indentation deflection mapping chart 130 observed from a composite cushioning structure formed from a diagonal boundary of latex injected into open-cell polyurethane foam to provide GPF. The units of the mapping chart 130 are raw force values in Newtons. The latex was injected such that there was a diagonal boundary between the portion of the sample that was injected and the portion that was not. A twenty-two (22) gauge needle was used to deliver the liquid latex, but some of the latex was spilled on the surface of the composite structure. As a result, the properties of the two zones of the GPF were not much different in terms of cushioning properties.

FIG. 14 is another indentation deflection mapping chart 140 observed from a composite cushioning structure formed from a diagonal boundary of latex injected into open-cell polyurethane foam to provide GPF. The units of chart 140 are raw force values in force normalized to the mean load. The latex was injected such that there was a diagonal boundary between the portion of the sample that was injected and the portion that was not. The variation in the properties of the two zones of the GPF was approximately+/−seven percent (7%) different in terms of cushioning properties.

FIG. 15 is an indentation deflection mapping chart 150 observed from a composite cushioning structure formed by injection of latex into open-cell polyurethane foam to provide GPF. The units of chart 150 are raw force values in Newtons. The latex was injected such that there was a diagonal boundary between the portion of the sample that was injected and the portion that was not. A sixteen (16) gauge needle was used to deliver the liquid latex with enhanced efficiency. As noted on the chart 150, which records raw force, the latex was injected into a 45 mm×45 mm square section in the middle of the composite cushioning structure. This pattern is clearly visible in the charted results in the chart 150. The peak stiffness is shown in the middle of the composite structure, and is about sixteen percent (16%) stiffer than the edges of the composite cushioning structure.

FIG. 16 is an indentation deflection mapping chart 160 observed from a composite cushioning structure formed by injection of latex into approximately half of the volume of the open-cell polyurethane foam to provide GPF. This GPF composite cushioning structure was injected with latex such that half of the composite structure was latex-reinforced and the other half was not. Additional latex than provided in the composite structures in FIGS. 13-15 was used in each injection to form the GPF composite structure. The stiffest portion of the injected half of the composite structure is shown to be approximately eighty percent (80%) stiffer than the uninjected half of the composite structure. This injection to form the GPF composite cushioning structure in FIG. 16 created a GPF having two-dimensional zoned structure having zoned cushioning properties. This sample was the source of the curves 55, 57 in FIG. 5.

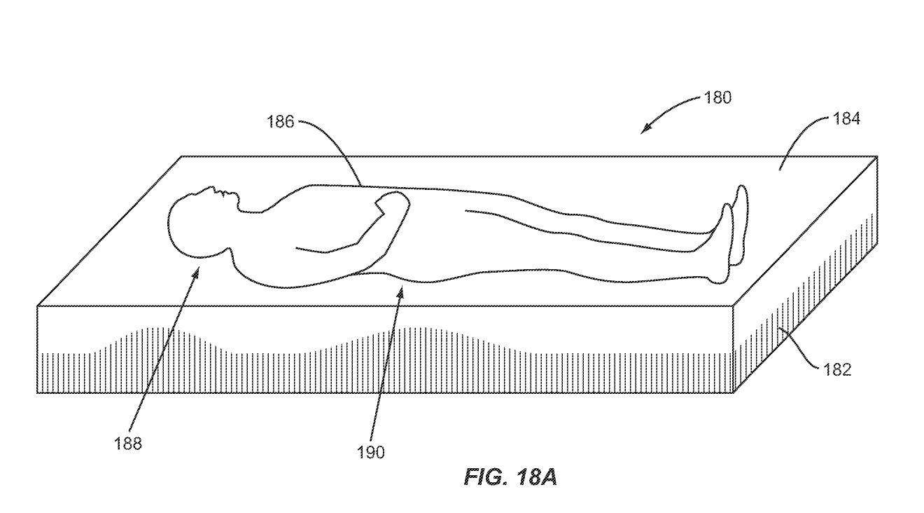

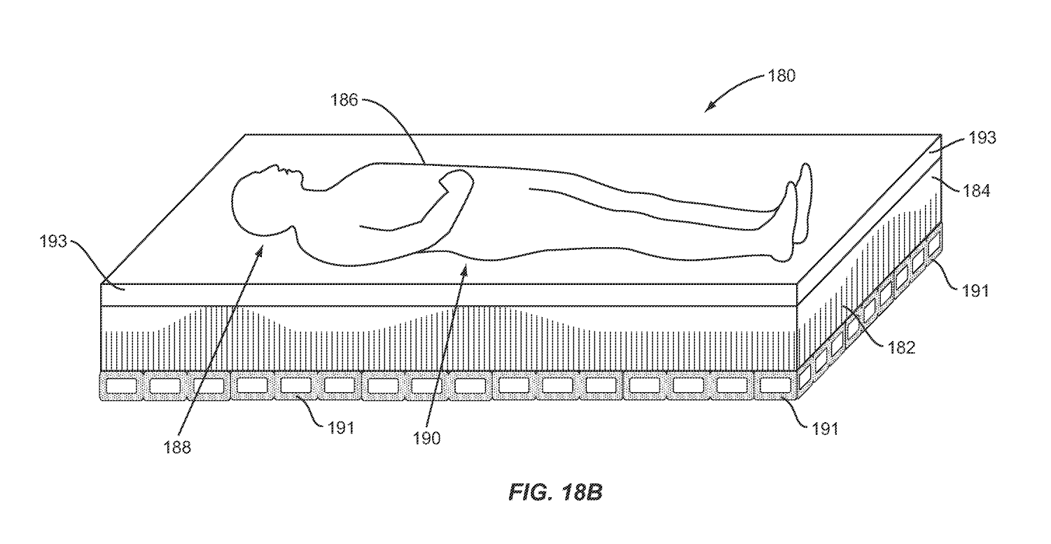

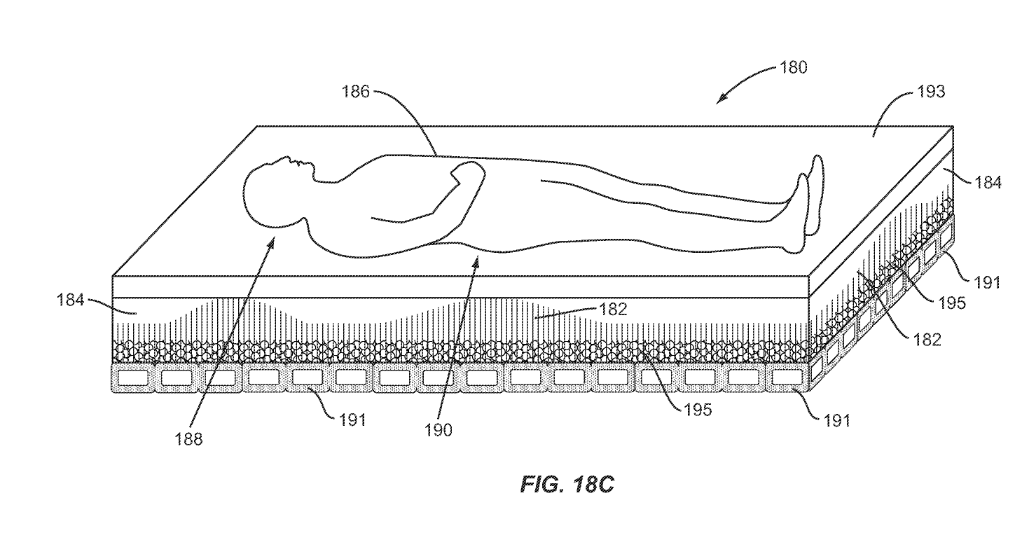

Bedding applications can be provided using the GPF composite cushioning structures disclosed herein. For example, FIG. 17 is an exemplary diagram of a perspective profile of a composite cushioning structure 172 having spatially variable cushioning properties suitable for a bedding or seating cushioning application. As illustrated therein, a first cushioning component 174, which may be like any of the aforementioned first cushioning component 48 options, is provided. A second cushioning component 176, which may be like any of the aforementioned second cushioning component 50 options, is disposed in a spatially variable manner with the first cushioning component 174. The spatial variation can vary in any dimension, as illustrated in FIG. 17, to provide gradient cushioning properties in either one, two, or three dimensions. In the exemplary composite cushioning structure 172 in FIG. 17, the gradient cushioning properties are provided in all three dimensions, X, Y, and Z. Further, the density of the second cushioning component 176 disposed in the first cushioning component 174 can be spatially variable or varied in any manner desired. This may be advantageous to be able to variably control and displace different cushioning properties to conform to variations in loads. For example, if the composite cushioning structure 172 is provided as a mattress, the second cushioning component 176 disposed in the first cushioning component 174 can be variable or varied in any manner desired to conform to the different properties or attributes of a human lying on the composite cushioning structure 172 acting as a mattress. An example of this concept is illustrated in FIGS. 18A-18C and discussed below.

FIG. 18A is another exemplary diagram of a perspective profile of a composite cushioning structure 180 having spatially variable cushioning properties suitable for a bedding or seating cushioning application. The composite cushioning structure 180 includes a first cushioning component 182, which may be like any of the aforementioned first cushioning component 48 options. A second cushioning component 184, which may be like any of the aforementioned second cushioning component 50 options, is disposed in a spatially variable manner with the first cushioning component 182. To provide greater support for the heavier portions of a person 186, such as the torso 188 and buttocks 190 of the person 186 lying on the composite cushioning structure 180 as illustrated in FIG. 18A, a higher concentration of the first cushioning component 182 having a greater firmness property can be disposed in the composite cushioning structure 180 in these areas, as illustrated in FIG. 18A. In this manner, the first cushioning component 182 and/or second cushioning component 184 can be varied in location, amount, and density to provide a custom sleep surface in the composite cushioning structure 180.

FIG. 18B is an exemplary diagram of a perspective profile of the composite cushioning structure 180 in FIG. 18A having spatially variable cushioning properties suitable for a bedding or seating cushioning application, but with a foam base 191 provided. The foam base 191 may be molded or extruded from any type of foam desired. U.S. Pat. Nos. 6,537,405 and 6,306,235 both entitled “Spiral formed products and methods of manufacture,” both of which are incorporated herein by reference in their entireties, disclose exemplary foam bases and methods of making same that may be used to provide the foam base 191 in FIG. 18B. An uppermost layer 193 of the composite cushioning structure 180 is provided in this embodiment as a separate layer, which may not include GPF.

FIG. 18C is exemplary diagram of a perspective profile of the composite cushioning structure 180 in FIG. 18A having spatially variable cushioning properties comprised of the second cushioning component 184 disposed in a non-woven mat 195 and disposed on the foam base 191 suitable for a bedding or seating cushioning application. The non-woven mat 195 can be employed to provide a reinforcing structure. The non-woven mat 195 can be comprised of fibers, which may be of variable thickness and/or density. When the foamed matrix of the second cushioning component 184 infiltrates the non-woven mat 195, the resulting composite cushioning structure 180 has property gradients associated with the variation in the reinforcement.

There are many possible choices of fiber and mat-forming process. The fibers can be synthetic or natural. With some synthetics, a melt-blowing process can be used to simultaneously spin the fibers and create the mat; by varying the melt flow rate, time the head spends over a particular location, and the distance of the head from the target surface, one can alter the thickness, density, and fiber structure at every location on the mat. Other fibers (synthetic and natural) can use processes such as needling or hydroentanglement to form mats. Common synthetic fibers would be those composed of polymers such as polyester, glass, polyamide (nylon), viscose rayon (cellulose), or polypropylene. Some of the natural fibers that could be used to form a mat for this application are: cotton, flax, hemp, jute, sisal, horsehair, bamboo, and coir as non-limiting examples.

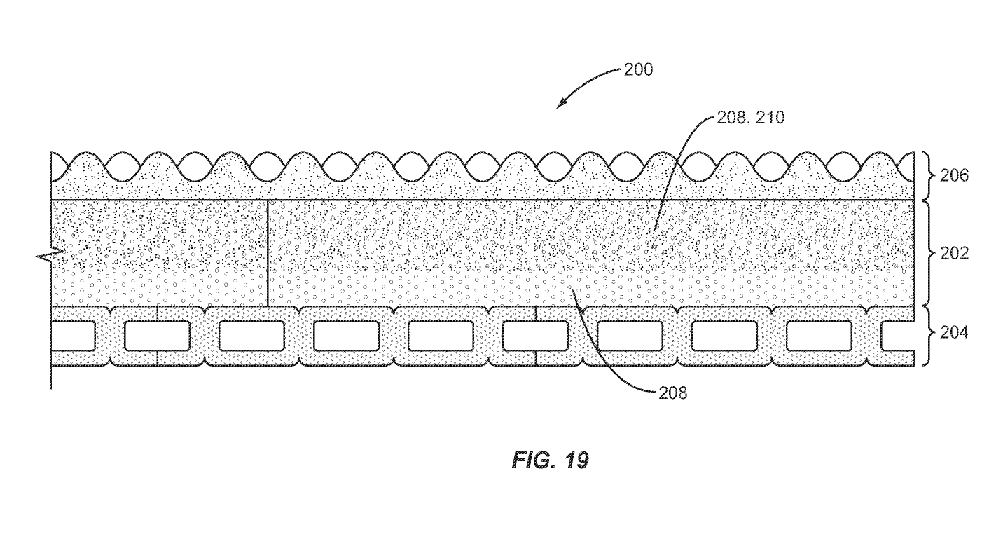

FIG. 19 is an exemplary cross-section profile of a mattress 200 employing a GPF composite cushioning structure 202 having spatially variable cushioning properties suitable for a bedding or seating cushioning application. In this embodiment, a base 204 is provided in the mattress 200. The GPF composite cushioning structure 202 is disposed between the base 204 and a cushioning layer 206. The GPF composite cushioning structure 202 is provided from a composite of a first cushioning component 208 and a second cushioning component 210 disposed within the first cushioning component 208 to provide spatially variable cushioning properties in the GPF composite cushioning structure 202. The first cushioning component 208 and the second cushioning component 210 may be provided according to any of the previously described examples and materials. The GPF composite cushioning structure 202 and the disposing of the second cushioning component 210 within the first cushioning component 208 may be provided according to any of the examples and processes described above.

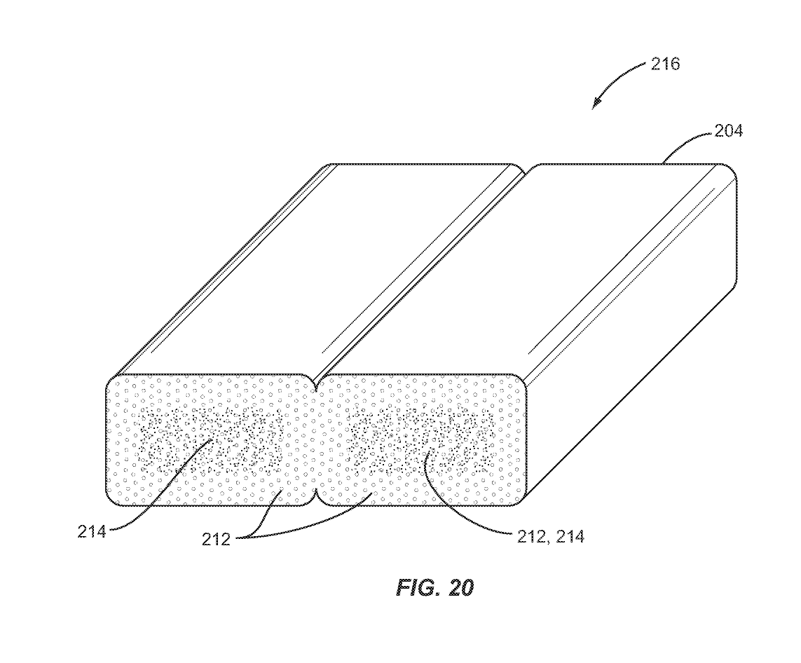

Other components of the mattress 200 may also be provided with a GPF composite cushioning structure having spatially variable cushioning properties. For example, FIG. 20 illustrates a portion of the base 204 in FIG. 19, but employing a first cushioning component 212 and a second cushioning component 214 disposed within the first cushioning component 212 to provide spatially variable cushion properties in a GPF composite cushioning structure 216. The first cushioning component 212 and the second cushioning component 214 may be provided according to any of the previously described examples and materials. The GPF composite cushioning structure 216 and the disposing of the second cushioning component 214 into the first cushioning component 212 may be provided according to any of the examples and processes described above. The GPF composite cushioning structure 216 could be provided as other supports in the mattress 200, including but not limited to side, edge, or corner supports.

Many modifications and other embodiments of the embodiments set forth herein will come to mind to one skilled in the art to which the embodiments pertain having the benefit of the teachings presented in the foregoing descriptions and the associated drawings. The first cushioning component and the second cushioning component(s) could be made from any material desired exhibiting any cushioning characteristics desired. For example, the first cushioning component(s) and the second cushioning component could be a thermoset or thermoplastic material. The material can be foamed. Thus, the first cushioning component and the second cushioning component(s) composition could be any combination of a thermoplastic/thermoplastic, thermoplastic/thermoset, thermoset/thermoplastic, or thermoset/thermoset, as examples. Further, the disclosure is not limited to two cushioning components for the composition. Three or more cushioning components could be employed, if desired.

Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. A composite cushioning structure, comprising:
a first cellular cushioning component provided in a solid phase having first cushioning and support characteristics; and
at least one second cushioning component having second cushioning and support characteristics, the at least one second cushioning component spatially variably distributed in at least a portion of the first cellular cushioning component to form the composite cushioning structure exhibiting a combination of the first and second cushioning support characteristics when placed under a load.

2. The composite cushioning structure of claim 1, wherein the at least one second cushioning component is spatially variably distributed in a non-solid phase in the at least a portion of the first cellular cushioning component, the at least one second cushioning component undergoing a transition from the non-solid phase into a solid phase within the first cellular cushioning component to form a bond with the first cellular cushioning component to form the composite cushioning structure.

3. The composite cushioning structure of claim 1, wherein the density of the at least one second cushioning component is spatially variably distributed in the at least a portion of the first cellular cushioning component as a function of density.

4. The composite cushioning structure of claim 3, wherein the density of the at least one second cushioning component spatially variably distributed in the at least a portion of the first cellular cushioning component is between 0.5 lbs. per cubic foot (lb./ft³) to 80 lbs./ft³.

5. The composite cushioning structure of claim 1, wherein the volume of the at least one second cushioning component is spatially variably distributed in the at least a portion of the first cellular cushioning component as a function of density.

6. The composite cushioning structure of claim 1, wherein the first cushioning and support characteristics of the first cellular cushioning component and the second support and cushioning characteristics of the at least one second cushioning component independently contribute to the combination of the first and second cushioning and support characteristics of the composite cushioning structure.

7. The composite cushioning structure of claim 1, wherein the at least one second cushioning component is injected into the at least a portion of the first cellular cushioning component.

8. The composite cushioning structure of claim 1, wherein the at least one second cushioning component is centrifuged into the at least a portion of the first cellular cushioning component.

9. The composite cushioning structure of claim 1, wherein the at least one second cushioning component is infusion blown into the at least a portion of the first cellular cushioning component.

10. The composite cushioning structure of claim 1, wherein the first cellular cushioning component is comprised of a cellular thermoplastic material and the at least one second cushioning component is comprised of a thermoset material.

11. The composite cushioning structure of claim 1, wherein the at least one second cushioning component is comprised of a cellular thermoplastic material and the first cellular cushioning component is comprised of a thermoset material.

12. The composite cushioning structure of claim 1, wherein the first cellular cushioning component is comprised from the group consisting of a cellular polypropylene foam, a cellular polypropylene copolymer foam, a cellular polystyrene foam, a cellular polyethylene foam, a cellular ethylene vinyl acetate (EVA) foam, a cellular thermoplastic olefin (TPO) foam, a cellular thermoplastic polyester foam, a cellular thermoplastic vulcanizate (TPV) foam, a cellular polyvinyl chloride (PVC) foam, a cellular chlorinated polyethylene foam, a cellular styrene block copolymer foam, a cellular ethylene methyl acrylate (EMA) foam, and a cellular ethylene butyl acrylate (EBA) foam.

13. The composite cushioning structure of claim 1, wherein the at least one second cushioning component is comprised from the group consisting of a cellular polypropylene foam, a cellular polypropylene copolymer foam, a cellular polystyrene foam, a cellular polyethylene foam, a cellular ethylene vinyl acetate (EVA) foam, a cellular thermoplastic olefin (TPO) foam, a cellular thermoplastic polyester foam, a cellular thermoplastic vulcanizate (TPV) foam, a cellular polyvinyl chloride (PVC) foam, a cellular chlorinated polyethylene foam, a cellular styrene block copolymer foam, a cellular ethylene methyl acrylate (EMA) foam, and a cellular ethylene butyl acrylate (EBA) foam.

14. The composite cushioning structure of claim 1, wherein the first cellular cushioning component is comprised from the group consisting of a polyurethane material, a melamine-formaldehyde material, silicone, a polyester material, natural latex rubber, and synthetic latex rubber.

15. The composite cushioning structure of claim 1, wherein the at least one second cushioning component is comprised from the group consisting of a polyurethane material, a melamine-formaldehyde material, silicone, a polyester material, natural latex rubber, and synthetic latex rubber.

16. The composite cushioning structure of claim 1, wherein the first cellular cushioning component is comprised of a open cellular material.

17. The composite cushioning structure of claim 1, wherein the first cellular cushioning component is comprised of a closed cellular material.

18. The composite cushioning structure of claim 1, wherein the first cellular cushioning component is comprised of a partially closed cellular material.

19. The composite cushioning structure of claim 1, further comprising an adhesive bond provided between the at least one second cushioning component and the at least a portion of the first cellular cushioning component.

20. The composite cushioning structure of claim 1, further comprising a cohesive bond provided between the at least one second cushioning component and the at least a portion of the first cellular cushioning component.

21. The composite cushioning structure of claim 1, further comprising a chemical bonding agent mixed in the at least one second cushioning component to provide a chemical bond between the at least one second cushioning component and the at least a portion of the first cellular cushioning component.

22. The composite cushioning structure of claim 1 disposed in an assembly comprised from the group consisting of a mattress assembly, a seat assembly, a cushion, a helmet assembly, a mat, a grip, packaging, a side support, an edge support, a bolster, and a coil.

23. The composite cushioning structure of claim 1, further comprising a non-woven mat disposed in the first cellular cushioning component receiving at least a portion of the at least one second cushioning component.

24. The composite cushioning structure of claim 1, wherein the first cellular cushioning component is provided in a cellular foam profile having at least one chamber disposed therein, wherein the at least one second cushioning component is spatially variably disposed in the at least one chamber of the cellular foam profile.

25. The composite cushioning structure of claim 24, wherein the at least one chamber is comprised of at least one closed chamber.

26. The composite cushioning structure of claim 24, wherein the at least one chamber is comprised of at least one open chamber.

27. A method for providing a composite cushioning structure, comprising:
providing a first cellular cushioning component provided in a solid phase having first cushioning and support characteristics; and
spatially variably distributing at least one second cushioning component having second cushioning and support characteristics in at least a portion of the first cellular cushioning component to form the composite cushioning structure exhibiting a combination of the first and second cushioning and support characteristics when placed under a load.

28. The method of claim 27, wherein spatially variably distributing the at least one second cushioning component further comprises spatially variably injecting the at least one second cushioning component into the at least a portion of the first cellular cushioning component.

29. The method of claim 27, wherein spatially variably distributing the at least one second cushioning component further comprises spatially variably centrifuging the at least one second cushioning component into the at least a portion of the first cellular cushioning component.

30. The method of claim 27, wherein spatially variably distributing the at least one second cushioning component further comprises spatially variably infusion blowing the at least one second cushioning component into the at least a portion of the first cellular cushioning component.

31. The method of claim 27, further comprising disposing an adhesive bond in the at least one second cushioning component.

32. The method of claim 27, further comprising forming a cohesive bond between the at least one second cushioning component and the at least a portion of the first cellular cushioning component.

33. The method of claim 27, further comprising mixing a chemical bonding agent in the at least one second cushioning component to provide a chemical bond between the at least one second cushioning component and the at least a portion of the first cellular cushioning component.

34. A mattress assembly for bedding or seating, comprising:
at least one mattress component comprised of a composite cushioning structure formed from a first cellular cushioning component and a at least one second cushioning component, comprising:
a first cellular cushioning component provided in a solid phase having first cushioning and support characteristics; and
at least one second cushioning component having second cushioning and support characteristics, the at least one second cushioning component spatially variably distributed in at least a portion of the first cellular cushioning component to form the cushioning structure exhibiting a combination of the first and second cushioning support characteristics when placed under a load.
